(19) United States
(12) Patent Application Publication
(10) Pub. No.: US 2024/0305344 A1
(43) Pub. Date: Sep. 12, 2024

(54) INTERFERENCE MEASUREMENT RESOURCES FOR CHANNEL STATE INFORMATION

(71) Applicant: QUALCOMM INCORPORATED, San Diego, CA (US)

(72) Inventors: Mostafa KHOSHNEVISAN, San Diego, CA (US); Chenxi HAO, Beijing (CN); Wanshi CHEN, San Diego, CA (US); Tao LUO, San Diego, CA (US); Peter GAAL, San Diego, CA (US); Xiaoxia ZHANG, San Diego, CA (US); Hao XU, Beijing (CN)

(21) Appl. No.: 18/261,979

(22) PCT Filed: Mar. 31, 2021
(86) PCT No.: PCT/CN2021/084321

§ 371 Date: Jul. 18, 2023

(51) Int. Cl. H04B 7/06; H04B 17/309; H04W 76/20

(52) U.S. Cl. CPC H04B 7/0626; H04B 7/0632; H04B 17/346; H04W 76/20

(57) ABSTRACT

Methods, systems, and devices for wireless communications are described. A user equipment (UE) may receive an indication of a first channel measurement resource (CMR) associated with a first transmission configuration indicator (TCI) state and a second CMR associated with a second TCI state. The UE may also receive an indication of a first interference measurement resource (IMR) associated with the first CMR and a second (IMR) associated with the second CMR. The UE may obtain an interference measurement using the first IMR, the second IMR, or both, for a channel state information (CSI) report for ajoint transmission hypothesis associated with the CMR and the second CMR. The UE may transmit the CSI report based at least in part on the interference measurement (s).

### CROSS REFERENCE

The present application is a 371 national stage filing of International PCT Application No. PCT/CN2021/084321 by KHOSHNEVISAN et al. entitled “INTERFERENCE MEASUREMENT RESOURCES FOR CHANNEL STATE INFORMATION,” filed Mar. 31, 2021, which is assigned to the assignee hereof, and which is expressly incorporated by reference in its entirety herein.

### FIELD OF TECHNOLOGY

The following relates to wireless communications, including interference measurement resources for channel state information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may send channel state information (CSI) reports to a base station. Techniques for improving CSI reporting may be desired.

### SUMMARY

The described techniques relate to improved methods, systems, devices, and apparatuses that support interference measurement resources for channel state information. A user equipment (UE) may generate a channel state information (CSI) report for a joint transmission hypothesis. To do so, the UE may use one or more interference measurement resources to measure interference for the joint transmission hypothesis. In one example, the UE may use an interference measurement resource that corresponds to a channel measurement resource configured for the joint transmission hypothesis. In another example, the UE may use multiple (e.g., two) interference measurement resources to measure interference for the joint transmission hypothesis. One or more of the multiple interference measurement resources may correspond to a channel resource measurement configured for the joint transmission hypothesis.

A method for wireless communication at a user equipment (UE) is described. The method may include receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state, receiving an indication of a first interference measurement resource and a second interference measurement resource, the first interference measurement resource associated with the first channel measurement resource and the second interference measurement resource associated with the second channel measurement resource, obtaining an interference measurement using the first interference measurement resource, the second interference measurement resource, or both, for a channel state information report for a joint transmission hypothesis associated with the first channel measurement resource and the second channel measurement resource, and transmitting the channel state information report based on the interference measurement.

An apparatus for wireless communication at a UE is described. The apparatus may include a processor, memory coupled with the processor, and instructions stored in the memory. The instructions may be executable by the processor to cause the apparatus to receive an indication of a first channel measurement resource and a second channel measurement resource, each configured for measuring channel state information reference signals, the first channel measurement resource associated with a first transmission configuration indicator state and the second channel measurement resource associated with a second transmission configuration indicator state, receive an indication of a first interference measurement resource and a second interference measurement resource, the first interference measurement resource associated with the first channel measurement resource and the second interference measurement resource associated with the second channel measurement resource, obtain an interference measurement using the first interference measurement resource, the second interference measurement resource, or both, for a channel state information report for a joint transmission hypothesis associated with the first channel measurement resource and the second channel measurement resource, and transmit the channel state information report based on the interference measurement.

Another apparatus for wireless communication at a UE is described. The apparatus may include means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state, means for receiving an indication of a first interference measurement resource and a second interference measurement resource, the first interference measurement resource associated with the first channel measurement resource and the second interference measurement resource associated with the second channel measurement resource, means for obtaining an interference measurement using the first interference measurement resource, the second interference measurement resource, or both, for a channel state information report for a joint transmission hypothesis associated with the first channel measurement resource and the second channel measurement resource, and means for transmitting the channel state information report based on the interference measurement.

A non-transitory computer-readable medium storing code for wireless communication at a UE is described. The code may include instructions executable by a processor to receive an indication of a first channel measurement resource and a second channel measurement resource, each configured for measuring channel state information reference signals, the first channel measurement resource associated with a first transmission configuration indicator state and the second channel measurement resource associated with a second transmission configuration indicator state, receive an indication of a first interference measurement resource and a second interference measurement resource, the first interference measurement resource associated with the first channel measurement resource and the second interference measurement resource associated with the second channel measurement resource, obtain an interference measurement using the first interference measurement resource, the second interference measurement resource, or both, for a channel state information report for a joint transmission hypothesis associated with the first channel measurement resource and the second channel measurement resource, and transmit the channel state information report based on the interference measurement.

Some examples of the method, apparatuses, and non-transitory computer-readable medium described herein may further include operations, features, means, or instructions for receiving an indication to use the first interference measurement resource, the second interference measurement resource, or both, for the channel state information report for the joint transmission hypothesis.

Some examples of the method, apparatuses, and non-transitory computer-readable medium described herein may further include operations, features, means, or instructions for determining that no interference measurement resource may be configured for the joint transmission hypothesis, where the interference measurement may be obtained using the first interference measurement resource, the second interference measurement resource, or both, based on the determination.

Some examples of the method, apparatuses, and non-transitory computer-readable medium described herein may further include operations, features, means, or instructions for determining that the UE may be to provide zero channel state information reports for single transmission hypotheses, where the interference measurement may be obtained using the first interference measurement resource, the second interference measurement resource, or both, based on the determination.

In some examples of the method, apparatuses, and non-transitory computer-readable medium described herein, the first transmission configuration indicator (TCI) state corresponds to a first receive beam and the second TCI state corresponds to a second receive beam and the method, apparatuses, and non-transitory computer-readable medium may include further operations, features, means, or instructions for determining that the UE does not support simultaneous multi-beam reception, using the first receive beam for the first interference measurement resource based on the determination, and using the second receive beam for the second interference measurement resource based on the determination.

In some examples of the method, apparatuses, and non-transitory computer-readable medium described herein, the channel state information report includes a channel quality indicator (CQI) and the method, apparatuses, and non-transitory computer-readable medium may include further operations, features, means, or instructions for determining the channel quality information (CQI) based on a sum of interference measured using the first interference measurement resource and interference measured using the second interference measurement resource.

Some examples of the method, apparatuses, and non-transitory computer-readable medium described herein may further include operations, features, means, or instructions for determining a first metric based on interference measured using the first interference measurement resource and signal measured using the first channel measurement resource, determining a second metric based on interference measured using the second interference measurement resource and signal measured using the second channel measurement resource, and including, in the channel state information report, a channel quality indicator (CQI) that may be based on the first metric and the second metric.

In some examples of the method, apparatuses, and non-transitory computer-readable medium described herein, the first transmission configuration indicator (TCI) state corresponds to a first receive beam and the second TCI state corresponds to a second receive beam and the method, apparatuses, and non-transitory computer-readable medium may include further operations, features, means, or instructions for determining that the UE supports simultaneous multi-beam reception and using the first and the second receive beams for the first interference measurement resource or the second interference measurement resource.

In some examples of the method, apparatuses, and non-transitory computer-readable medium described herein, the channel state information report includes a channel quality indicator (CQI) and the method, apparatuses, and non-transitory computer-readable medium may include further operations, features, means, or instructions for determining the CQI based on interference measured using the first interference measurement resource and interference measured using the second interference measurement resource.

Some examples of the method, apparatuses, and non-transitory computer-readable medium described herein may further include operations, features, means, or instructions for determining an order for the first channel measurement resource and the second channel measurement resource, where the first and the second receive beams may be used for the first interference measurement resource or the second interference measurement resource based on the order.

Some examples of the method, apparatuses, and non-transitory computer-readable medium described herein may further include operations, features, means, or instructions for determining a relationship between an identifier of a channel state information reference signal (CSI-RS) for the first channel measurement resource and an identifier of a channel state information (CSI)-RS for the second channel measurement resource, where the first and the second receive beams may be used for the first interference measurement resource or the second interference measurement resource based on the relationship.

Some examples of the method, apparatuses, and non-transitory computer-readable medium described herein may further include operations, features, means, or instructions for determining that a transmission reception point (TRP) associated with the second channel measurement resource may be to refrain from transmitting during the first interference measurement resource, where the interference measurement may be obtained using the first interference measurement resource based on the determination.

In some examples of the method, apparatuses, and non-transitory computer-readable medium described herein, the first transmission configuration indicator (TCI) state corresponds to a first receive beam and the second TCJ state corresponds to a second receive beam and the method, apparatuses, and non-transitory computer-readable medium may include further operations, features, means, or instructions for using the first and the second receive beams for the first interference measurement resource and using the first and the second receive beams for the second interference measurement resource.

In some examples of the method, apparatuses, and non-transitory computer-readable medium described herein, the interference measurement may be obtained using the first interference measurement resource or the second interference measurement resource and the method, apparatuses, and non-transitory computer-readable medium may include further operations, features, means, or instructions for receiving an indication of a third interference measurement resource configured for the joint transmission hypothesis and obtaining an interference measurement using the third interference measurement resource for the channel state information report for the joint transmission hypothesis.

A method for wireless communication at a UE is described. The method may include receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state, receiving an indication of a first interference measurement resource and a second interference measurement resource configured for measuring interference for a joint transmission hypothesis associated with the first channel measurement resource and the second channel measurement resource, obtaining, for the joint transmission hypothesis, a first interference measurement using the first interference measurement resource and a second interference measurement using the second interference measurement resource, and transmitting a channel state information report based on the first and second interference measurements.

An apparatus for wireless communication at a UE is described. The apparatus may include a processor, memory coupled with the processor, and instructions stored in the memory. The instructions may be executable by the processor to cause the apparatus to receive an indication of a first channel measurement resource and a second channel measurement resource configured for measuring channel state information reference signals, the first channel measurement resource associated with a first transmission configuration indicator state and the second channel measurement resource associated with a second transmission configuration indicator state, receive an indication of a first interference measurement resource and a second interference measurement resource configured for measuring interference for a joint transmission hypothesis associated with the first channel measurement resource and the second channel measurement resource, obtain, for the joint transmission hypothesis, a first interference measurement using the first interference measurement resource and a second interference measurement using the second interference measurement resource, and transmit a channel state information report based on the first and second interference measurements.

Another apparatus for wireless communication at a UE is described. The apparatus may include means for receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state, means for receiving an indication of a first interference measurement resource and a second interference measurement resource configured for measuring interference for a joint transmission hypothesis associated with the first channel measurement resource and the second channel measurement resource, means for obtaining, for the joint transmission hypothesis, a first interference measurement using the first interference measurement resource and a second interference measurement using the second interference measurement resource, and means for transmitting a channel state information report based on the first and second interference measurements.

A non-transitory computer-readable medium storing code for wireless communication at a UE is described. The code may include instructions executable by a processor to receive an indication of a first channel measurement resource and a second channel measurement resource configured for measuring channel state information reference signals, the first channel measurement resource associated with a first transmission configuration indicator state and the second channel measurement resource associated with a second transmission configuration indicator state, receive an indication of a first interference measurement resource and a second interference measurement resource configured for measuring interference for a joint transmission hypothesis associated with the first channel measurement resource and the second channel measurement resource, obtain, for the joint transmission hypothesis, a first interference measurement using the first interference measurement resource and a second interference measurement using the second interference measurement resource, and transmit a channel state information report based on the first and second interference measurements.

In some examples of the method, apparatuses, and non-transitory computer-readable medium described herein, the first transmission configuration indicator (TCI) state corresponds to a first receive beam and the second TCJ state corresponds to a second receive beam and the method, apparatuses, and non-transitory computer-readable medium may include further operations, features, means, or instructions for using the first receive beam for the first interference measurement resource and using the second receive beam for measuring during the second interference measurement resource.

Some examples of the method, apparatuses, and non-transitory computer-readable medium described herein may further include operations, features, means, or instructions for receiving an indication of a third interference measurement resource and a fourth interference measurement resource each configured for measuring interference for a respective single transmission hypothesis, where the third interference measurement resource and the fourth interference measurement resource may be different than the first interference measurement resource and the second interference measurement resource.

In some examples of the method, apparatuses, and non-transitory computer-readable medium described herein, the channel state information report includes a channel quality indicator (CQI) and the method, apparatuses, and non-transitory computer-readable medium may include further operations, features, means, or instructions for determining the CQI based on a sum of the first interference measurement and the second interference measurement.

A method for wireless communication is described. The method may include indicating a first channel measurement resource and a second channel measurement resource configured for measuring channel state information reference signals, the first channel measurement resource associated with a first transmission configuration indicator state and the second channel measurement resource associated with a second transmission configuration indicator state, indicating a first interference measurement resource and a second interference measurement resource, the first interference measurement resource associated with the first channel measurement resource and the second interference measurement resource associated with the second channel measurement resource, and receiving a channel state information report for a joint transmission hypothesis associated with the first channel measurement resource and the second channel measurement resource, the channel state information report based on one or more interference measurements obtained using the first interference measurement resource, the second interference measurement resource, or both.

An apparatus for wireless communication is described. The apparatus may include a processor, memory coupled with the processor, and instructions stored in the memory. The instructions may be executable by the processor to cause the apparatus to indicate a first channel measurement resource and a second channel measurement resource configured for measuring channel state information reference signals, the first channel measurement resource associated with a first transmission configuration indicator state and the second channel measurement resource associated with a second transmission configuration indicator state, indicate a first interference measurement resource and a second interference measurement resource, the first interference measurement resource associated with the first channel measurement resource and the second interference measurement resource associated with the second channel measurement resource, and receive a channel state information report for a joint transmission hypothesis associated with the first channel measurement resource and the second channel measurement resource, the channel state information report based on one or more interference measurements obtained using the first interference measurement resource, the second interference measurement resource, or both.

Another apparatus for wireless communication is described. The apparatus may include means for indicating a first channel measurement resource and a second channel measurement resource configured for measuring channel state information reference signals, the first channel measurement resource associated with a first transmission configuration indicator state and the second channel measurement resource associated with a second transmission configuration indicator state, means for indicating a first interference measurement resource and a second interference measurement resource, the first interference measurement resource associated with the first channel measurement resource and the second interference measurement resource associated with the second channel measurement resource, and means for receiving a channel state information report for a joint transmission hypothesis associated with the first channel measurement resource and the second channel measurement resource, the channel state information report based on one or more interference measurements obtained using the first interference measurement resource, the second interference measurement resource, or both.

A non-transitory computer-readable medium storing code for wireless communication is described. The code may include instructions executable by a processor to indicate a first channel measurement resource and a second channel measurement resource configured for measuring channel state information reference signals, the first channel measurement resource associated with a first transmission configuration indicator state and the second channel measurement resource associated with a second transmission configuration indicator state, indicate a first interference measurement resource and a second interference measurement resource, the first interference measurement resource associated with the first channel measurement resource and the second interference measurement resource associated with the second channel measurement resource, and receive a channel state information report for a joint transmission hypothesis associated with the first channel measurement resource and the second channel measurement resource, the channel state information report based on one or more interference measurements obtained using the first interference measurement resource, the second interference measurement resource, or both.

Some examples of the method, apparatuses, and non-transitory computer-readable medium described herein may further include operations, features, means, or instructions for indicating that a UE may be to use the first interference measurement resource, the second interference measurement resource, or both, for the channel state information report for the joint transmission hypothesis.

Some examples of the method, apparatuses, and non-transitory computer-readable medium described herein may further include operations, features, means, or instructions for determining that no interference measurement resource may be configured for the joint transmission hypothesis, where the indication to use the first interference measurement resource, the second interference measurement resource, or both, may be transmitted based on the determination.

Some examples of the method, apparatuses, and non-transitory computer-readable medium described herein may further include operations, features, means, or instructions for configuring a UE to provide zero channel state information reports for single transmission hypotheses, where the indication to use the first interference measurement resource, the second interference measurement resource, or both, may be transmitted based on the determination.

Some examples of the method, apparatuses, and non-transitory computer-readable medium described herein may further include operations, features, means, or instructions for determining that a transmission reception point (TRP) associated with the second channel measurement resource may be to refrain from transmitting during the first interference measurement resource, where the indication to use the first interference measurement resource, the second interference measurement resource, or both, may be transmitted based on the determination.

Some examples of the method, apparatuses, and non-transitory computer-readable medium described herein may further include operations, features, means, or instructions for determining that a UE does not support simultaneous multi-beam reception and transmitting an indication of a third interference measurement resource configured for the joint transmission hypothesis based on the determination, where the channel state information report may be based on an interference measurement obtained using the third interference measurement resource.

In some examples of the method, apparatuses, and non-transitory computer-readable medium described herein, the first interference measurement resource and the second interference measurement resource may be indicated in a channel state information report configuration message.

A method for wireless communication is described. The method may include indicating a first channel measurement resource and a second channel measurement resource configured for measuring channel state information reference signals, the first channel measurement resource associated with a first transmission configuration indicator state and the second channel measurement resource associated with a second transmission configuration indicator state, indicating a first interference measurement resource and a second interference measurement resource configured for measuring interference for a joint transmission hypothesis associated with the first channel measurement resource and the second channel measurement resource, and receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

An apparatus for wireless communication is described. The apparatus may include a processor, memory coupled with the processor, and instructions stored in the memory. The instructions may be executable by the processor to cause the apparatus to indicate a first channel measurement resource and a second channel measurement resource configured for measuring channel state information reference signals, the first channel measurement resource associated with a first transmission configuration indicator state and the second channel measurement resource associated with a second transmission configuration indicator state, indicate a first interference measurement resource and a second interference measurement resource configured for measuring interference for a joint transmission hypothesis associated with the first channel measurement resource and the second channel measurement resource, and receive a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

Another apparatus for wireless communication is described. The apparatus may include means for indicating a first channel measurement resource and a second channel measurement resource configured for measuring channel state information reference signals, the first channel measurement resource associated with a first transmission configuration indicator state and the second channel measurement resource associated with a second transmission configuration indicator state, means for indicating a first interference measurement resource and a second interference measurement resource configured for measuring interference for a joint transmission hypothesis associated with the first channel measurement resource and the second channel measurement resource, and means for receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

A non-transitory computer-readable medium storing code for wireless communication is described. The code may include instructions executable by a processor to indicate a first channel measurement resource and a second channel measurement resource configured for measuring channel state information reference signals, the first channel measurement resource associated with a first transmission configuration indicator state and the second channel measurement resource associated with a second transmission configuration indicator state, indicate a first interference measurement resource and a second interference measurement resource configured for measuring interference for a joint transmission hypothesis associated with the first channel measurement resource and the second channel measurement resource, and receive a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

Some examples of the method, apparatuses, and non-transitory computer-readable medium described herein may further include operations, features, means, or instructions for determining that a UE does not support simultaneous multi-beam reception, where the first interference measurement resource and the second interference measurement resource may be indicated based on the determination.

Some examples of the method, apparatuses, and non-transitory computer-readable medium described herein may further include operations, features, means, or instructions for configuring the UE to provide one or more channel state information reports for single transmission hypotheses, where the first interference measurement resource and the second interference measurement resource may be indicated based on configuring the UE.

Some examples of the method, apparatuses, and non-transitory computer-readable medium described herein may further include operations, features, means, or instructions for determining that a first transmission reception point (TRP) associated with the first channel measurement resource may be scheduled to transmit during the second interference measurement resource and that a second TRP associated with the second channel measurement resource may be scheduled to transmit during the first interference measurement resource, where the first interference measurement resource and the second interference measurement resource may be indicated based on the determination.

Some examples of the method, apparatuses, and non-transitory computer-readable medium described herein may further include operations, features, means, or instructions for indicating a third interference measurement resource and a fourth interference measurement resource each configured for measuring interference for a respective single transmission hypothesis, where the third interference measurement resource may be associated with the first channel measurement resource and the second interference measurement resource may be associated with the second channel measurement resource and receiving a second channel state information report for at least one of the single transmission hypotheses, the second channel state information report including a second interference metric that may be based on a third interference measurement obtained using the third interference measurement resource or a fourth interference measurement obtained using the fourth interference measurement resource.

### BRIEF DESCRIPTION OF THE DRAWINGS

FIG. 1 illustrates an example of a wireless communications system that supports interference measurement resources for channel state information in accordance with aspects of the present disclosure.

FIG. 2 illustrates an example of a wireless communications system that supports interference measurement resources for channel state information in accordance with aspects of the present disclosure.

FIG. 3 illustrates an example of a process flow that supports interference measurement resources for channel state information in accordance with aspects of the present disclosure.

FIG. 4 illustrates an example of a process flow that supports interference measurement resources for channel state information in accordance with aspects of the present disclosure.

FIGS. 5 and 6 show block diagrams of devices that support interference measurement resources for channel state information in accordance with aspects of the present disclosure.

FIG. 7 shows a block diagram of a communications manager that supports interference measurement resources for channel state information in accordance with aspects of the present disclosure.

FIG. 8 shows a diagram of a system including a device that supports interference measurement resources for channel state information in accordance with aspects of the present disclosure.

FIGS. 9 and 10 show block diagrams of devices that support interference measurement resources for channel state information in accordance with aspects of the present disclosure.

FIG. 11 shows a block diagram of a communications manager that supports interference measurement resources for channel state information in accordance with aspects of the present disclosure.

FIG. 12 shows a diagram of a system including a device that supports interference measurement resources for channel state information in accordance with aspects of the present disclosure.

FIGS. 13 through 16 show flowcharts illustrating methods that support interference measurement resources for channel state information in accordance with aspects of the present disclosure.

### DETAILED DESCRIPTION

In some wireless communications systems, a user equipment (UE) may report channel state information (CSI) to a base station to improve communications. The UE may determine the CSI by performing channel measurements and interference measurements. For example, the UE may measure channel state information reference signals (CSI-RS) in resources configured for channel measurements, which may be referred to as channel measurement resources (CMRs)). The UE may also measure interference during resources configured for interference measurements (which may be referred to as interference measurement resources (IMRs)). Each CMR may be associated with a respective transmission configuration indicator (TCI) state and/or transmission reception point (TRP). Each CMR may also have a corresponding IMR (e.g., as configured by the base station).

The UE may generate CSI for various single TRP (sTRP) hypotheses which correspond to CMRs configured for that UE. To generate the CSI for an sTRP, the UE may measure interference using the IMR configured for that sTRP. The UE may also generate CSI for one or more multi-TRP (mTRP) hypotheses each of which corresponds to a respective pair of CMRs. An mTRP hypothesis may also be referred to as joint transmission hypothesis or a non-coherent joint transmission (NCJT) hypothesis and an sTRP hypothesis may also be referred to as a non-joint transmission hypothesis or a single transmission hypothesis. To obtain interference information that can be used to generate CSI for an NCJT hypothesis, the UE may use an additional IMR that is configured for the NCJT hypothesis. Thus, there may be a one-to-one mapping between IMRs and hypotheses. But such a technique may be inefficient or impracticable in certain scenarios, among other disadvantages.

According to the techniques described herein, CSI reporting for an NCJT hypothesis may be improved by strategically using, for the NCJT hypothesis, one or more IMRs corresponding to the CMRs configured for the NCJT hypothesis (e.g., rather than using an additional IMR). Additionally or alternatively, CSI reporting for an NCJT hypothesis may be improved by using two IMRs for the NCJT hypothesis. Both IMRs may be configured exclusively for the NCJT hypothesis or one IMR may be configured exclusively for the NCJT hypothesis and the other IMR may correspond to a CMR configured for the NCJT hypothesis.

Aspects of the disclosure are initially described in the context of wireless communications systems. Aspects of the disclosure are further described in the context of process flows. Aspects of the disclosure are further illustrated by and described with reference to apparatus diagrams, system diagrams, and flowcharts that relate to interference measurement resources for channel state information.

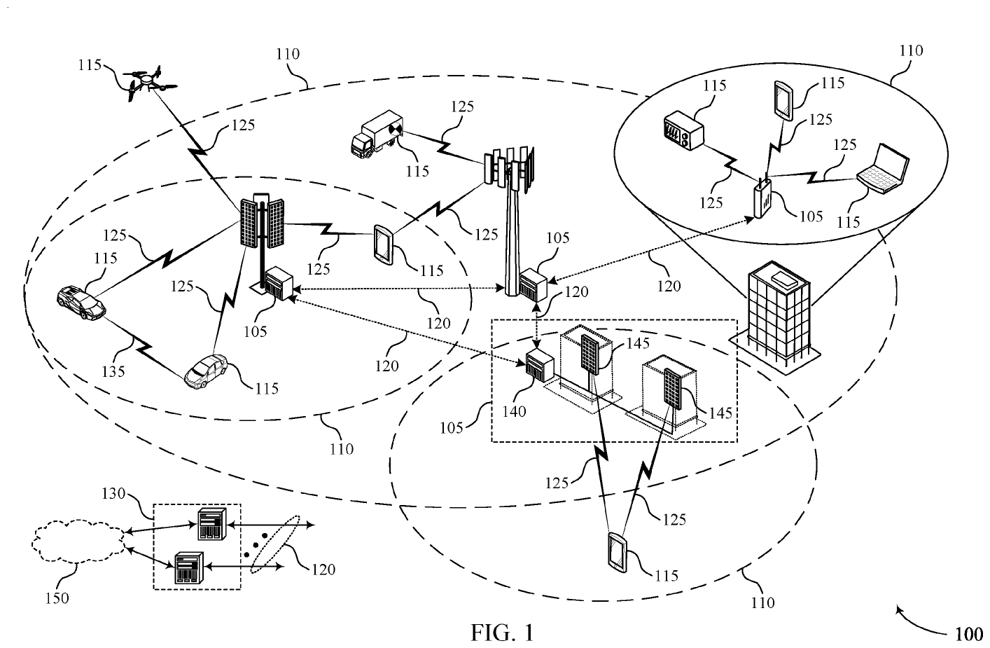

FIG. 1 illustrates an example of a wireless communications system 100 that supports interference measurement resources for channel state information in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of TS=1/(Δfₘₐₓ−N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5 GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a base station may send to a UE 115 a CSI report configuration that configures resources for a CSI report. The CSI report configuration may be linked to one or more resource settings, each of which may have an active resource set. For example, the CSI report configuration may be linked to a single resource setting (e.g., a resource setting for CMR), to two resource settings (e.g., a resource setting for CMR and a resource setting for CSI-IM or non-zero-power IMR (NZP-IMR)), or to three resource settings (e.g., a resource setting for CMR, a resource setting for CSI-IM, and a resource setting for NZP-IMR). Each resource setting may have multiple resource sets, one of which may be an active resource set that the UE 115 is to use for CSI measurements. For example, an CMR resource setting may have n CMR resource sets, one of which may be configured for channel measurements. A CSI-IM resource setting may have m CSI-IM resource sets, one of which may be configured for interference measurements. And an NZP-IMR resource setting may have s NZP-IMR resource sets, one of which is configured for interference measurements. An active resource set may include one or more resources (e.g., Nresources).

Each CMR in a CMR resource set may be associated with (e.g., correspond to, be configured with) a respective transmission configuration indicator (TCI) state that includes information about quasi-co-location (QCL) relationships between downlink reference signals and/or ports. A TCI state may also be referred to as a transmission reception point (TRP). Thus, each CMR may be associated with a TRP. A CMR may also be associated with a respective CSI-IM resource (referred to henceforth as an IMR) from the active CSI-IM resource set. For example, each CMR may have a corresponding IMR in that each CMR may be resource-wise associated with an IMR resource (e.g., by the ordering of the CMR and the IMR in the corresponding resource sets). Thus, in some examples (e.g., in the sTRP context), there may be a one-to-one correspondence between CMRs and IMRs and the quantity of CMRs may be equal to the quantity of IMRs.

A CMR in a CMR resource set may also be associated with (e.g., correspond to, be configured for) a single-TRP (sTRP) hypothesis. If the TRPs associated with a UE 115 support joint transmissions, a pair of CMR resources in the CMR resource set may be configured for the NCJT hypothesis associated with those TRPs. The CMRs that make up a pair of CMR resources for an NCJT hypothesis may be selected from two groups of CMR resources determined by the base station 105 (e.g., one CMR may be selected from the first group and the other CMR may be selected from the second group). So, one or more CMRs in a CMR resource set may be configured for respective sTRP hypotheses and one or more pairs of CMRs in the CMR resource set may be configured for respective NCJT hypotheses. A CMR in a CMR resource set may be used for both a NCJT hypothesis and an sTRP hypothesis.

A UE 115 may be configured to provide one or more CSI reports corresponding to various hypotheses.

In a first CSI reporting option (referred to as Option 1), the UE 115 may be configured to report a CSI report for the NCJT hypotheses configured for the UE and X (e.g., 0, 1, 2) CSI reports for the sTRP hypothesis configured for the UE 115. A CSI report for an NCJT (referred to as an NCJT CSI report) may be a CSI report that is associated with multiple (e.g., two) CMRs, which in turn may be configured with two corresponding TCI states associated with two TRPs, respectively. In the first option (Option 1), the UE 115 may generate CSI for each NCJT hypothesis and select the best CSI to report to the base station 105. If X is equal to zero (e.g., the UE 115 is configured to provide zero CSI reports for sTRP hypotheses), the UE 115 may not generate CSI for any sTRP hypotheses. So, when X is equal to zero in Option 1, the CMRs in any of the two groups may not be used for sTRP hypotheses (rather, the CMRs may be used as pairs for NCJT hypotheses).

In a second CSI reporting option (Option 2), the UE 115 may be configured to report a single (e.g., best) CSI report for the collection of NCJT and sTRP hypotheses configured for the UE 115. In either Option 1 or Option 2, a CSI report may include a CSI-RS resource indicator (CRI) that indicates the CSI-RS resource (e.g., the CMR) to which the CSI report corresponds.

So, a UE 115 may be configured to provide a CSI report for an NCJT hypothesis and/or a CSI report for one or more sTRP hypotheses. To generate a CSI report for an sTRP hypothesis, a UE 115 may measure interference using the IMR that is associated with the CMR corresponding to that sTRP hypothesis. To generate an NCJT CSI report, a UE 115 may measure interference using an IMR that is separate from the IMR(s) associated with the CMRs corresponding to the NCJT hypothesis (referred to as NCJT CMRs). But using a single, separate IMR to measure interference for an NCJT CSI report may be inefficient or impracticable in certain scenarios.

According to the techniques described herein, a UE 115 may improve NCJT CSI reporting by using one or more of the IMRs corresponding to the NCJT CMRs to measure interference for the NCJT hypothesis. Additionally or alternatively, the UE 115 may improve NCJT CSI reporting by using two IMRs for the NCJT hypothesis. The two IMRs may be configured exclusively for the NCJT hypothesis or one IM R may be configured exclusively for the NCJT hypothesis and the other IMR for an NCJT CMR.

A hypothesis may also be referred to as a transmission hypothesis, a measurement hypothesis, a CSI hypothesis, or other suitable terminology.

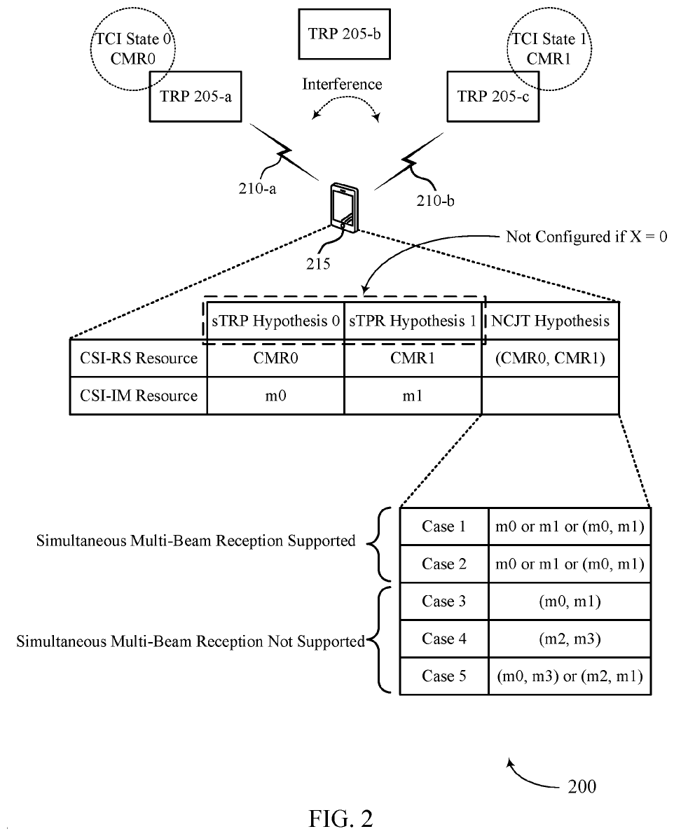

FIG. 2 illustrates an example of a wireless communications system 200 that supports interference measurement resources for channel state information in accordance with aspects of the present disclosure. The wireless communications system 200 may include TRP 205-a, TRP 205-b, and TRP 205-c, as well as a UE 215. The UE 215 may use an IM R associated with an NCJT CMR to obtain an interference measurement for the NCJT hypothesis. Additionally or alternatively, the UE 215 may use two IMRs to obtain interference measurements for an NCJT hypothesis. In FIG. 2, TRP 205-a and TRP 205-c may be associated with a same base station and may be included in a measurement set for the UE 215. TRP 205-b may be unassociated with the base station and may not be included in the measurement set for the UE 215.

The UE 215 may receive communications from TRP 205-a (e.g., over communication link 210-b) and TRP 205-b (e.g., over communication link 210-b). The communications from TRP 205-a and TRP 205-c may be at least partially coordinated by the base station associated with TRP 205-a and TRP 205-c. The UE 215 may not receive communications from TRP 205-b but may measure interference from TRP 205-b as described herein and below.

In some examples, the UE 215 may receive separate (non-joint, single) communications from TRP 205-a and TRP 205-b, where a separate communication is a communication from one of the TRPs 205 independent of the other TRP 205. In some examples, the UE 215 may receive joint communications from the TRPs 205, where a joint communication is a communication from both the TRPs 205. Thus, the TRPs 205 may be configured to support separate transmissions and joint transmissions. In some examples, the TRPs 205 may be configured to support coherent joint transmissions, non-coherent joint transmissions, or both. A coherent joint transmission may be a transmission in which transmission weights at the TRPs 205 are selected (based on knowledge of the channels between the UE 215 and the TRPs 205) to focus the energy at the UE 215 (e.g., in a type of non-co-located beamforming). A non-coherent joint transmission may be a transmission in which the TRPs 205 cooperate to increase the power gain of the transmission, to increase the rank that the UE 215 may be able to receive (for capacity enhancements), or to increase the diversity of the transmission (e.g. for reliability enhancements especially when the signal from one of the TRPs may be blocked due to harsh propagation environment).

The UE 215 may receive a CSI report configuration that indicates CMRs (referred to as CSI-RS resources in FIG. 2) and IMRs that the UE 215 is to use for one or more CSI reports.

For example, the CSI report configuration may indicate a first CMR (CMR0) and a second CMR (CMR1). CMR0 may be associated with TRP 205-a and a first TCI state (TCI state 0) configured for TRP 205-a. CMR1 may be associated with TRP 205-b and a second TCI state (TCI state 1) configured for TRP 205-b. Thus, for scenarios other than X=0 for Option 1, CMR0 may be associated with (correspond to, be configured for) a first sTRP hypothesis (sTRP hypothesis 0) and CMR1 may be associated with (correspond to, be configured for) a second sTRP hypothesis (sTRP hypothesis 1). A UE such as the UE 215 may determine one or more channel characteristics by measuring a CSI-RS that is contained in a CMR.

In addition to indicating CMRs, the CSI report configuration may also indicate IMRs (referred to as CSI-IM resources in FIG. 2). For example, the CSI report configuration may indicate a first IMR (denoted m0) that is associated with CMR0 and a second IMR (denoted m1) that is associated with CMR1. Thus, for scenarios other than X=0 for Option 1, IMR m0 and IMR m1 may be configured for the respective sTRP hypothesis corresponding to CMR0 and CMR1. An IMR may be a set of resources (e.g., time and frequency resources, such as resource elements) that do not contain any signaling, such as a CSI-RS. So, an IMR may be different from an NZP-IMR which may contain signaling, such as a CSI-RS.

A UE such as the UE 215 may use an IMR to detect interference by measuring the energy detected over the IMR using one or more receive beams. An IMR may be received with the same spatial filter and/or receive beam as the corresponding CMR (e.g., because the CQL relationship between an IMR and a CMR may be QCL TypeD). That is, the UE 215 may measure interference using the same receive beam as that used for channel measurement. The receive beam for a CMR may be based on the TCI state configured for the CMR.

The UE 215 may determine CSI for one or more transmission hypotheses involving TRP 205-a and TRP 205-c. One or more metrics or parameters of the CSI for a transmission hypothesis may be based on interference detected for that transmission hypothesis.

To obtain an interference measurement for sTRP hypothesis 0, the UE 215 may use IMR m0 and a receive beam that corresponds to TCI state 0 (e.g., the TCI state associated with CMR0). The interference measured by the UE 215 for sTRP hypothesis 0 may include interference from TRP 205-b, interference from TRP 205-c, or both. To obtain an interference measurement for sTRP hypothesis 1, the UE 215 may use IMR m1 and a receive beam that corresponds to TCI state 1 (e.g., the TCI state associated with CMR1). The interference measured by the UE 215 for sTRP hypothesis 1 may include interference from TRP 205-a, interference from TRP 205-b, or both. The UE 215 may not obtain interference measurements for sTRP hypothesis 0 and sTRP hypothesis 1 if the UE 215 is configured with X=0 for Option 1.

To obtain an interference measurement for the NCJT hypothesis, the UE 215 may use one or more IMRs. The various IMR options for the NCJT hypothesis are shown in the expanded table in FIG. 2, with different options corresponding to different scenarios. An interference measurement for the NCJT hypothesis may reflect interference from TRPs outside the measurement set for the UE 215 but may not reflect interference from TRPs in the measurement set. For example, the interference measurement for the NCTJ hypothesis in FIG. 2 may reflect interference from TRP 205-b but not interference from TRP 205-a or TRP 205-c.

In a first scenario (Case 1), one or both of CMR0 and CMR1 may not be used for a respective sTRP hypothesis. Case 1 may occur when X=0 for CSI reporting Option 1 (e.g., when the UE 215 is configured to provide zero CSI reports for the sTRP hypotheses). If neither CMR is used for an sTRP hypothesis, one or both of the IMRs can be used for the NCJT hypothesis. If only one CMR is used for an sTRP hypothesis, the IMR corresponding to the other CMR may be used for the NCJT hypothesis. Thus, in Case 1, the UE 215 may use IMR m0, IMR m1, or both, for the NCJT hypothesis (depending on which CMR(s) are configured for sTRP hypotheses). For example, the UE 215 may obtain one or more interference measurements using IMR m0, IMR m1, or both, and use the interference measurement(s) to generate CSI for the NCJT hypothesis.

Still referring to Case 1, if the UE 215 uses both IMR m0 and IMR m1 for the NCJT hypothesis (and if the UE 215 is capable of simultaneous multi-beam reception), the UE 215 may use two receive beams to perform the interference measurements for each IMR. For example, the UE 215 may use a first receive beam corresponding to TCI state 0 (and therefore corresponding to CMR0) and a second receive beam corresponding to TCI state 1 (and therefore corresponding to CMR1) to perform interference measurements using IMR m0 and IMR m1. The UE 215 may average the interference measurements to obtain an average interference measurement, which may provide greater accuracy relative to other techniques. If the UE only uses IMR m0 for the NCJT hypothesis, the UE 215 may use the first receive beam and the second receive beam to perform the interference measurement. If the UE only uses IMR m1 for the NCJT hypothesis, the UE 215 may use the first receive beam and the second receive beam to perform the interference measurement.

In a second scenario (Case 2), one or both of TRP 205-a and TRP 205-c may be muted (e.g., configured to refrain from transmitting) during one or both of the IMRs. If TRP 205-c is muted during IMR m0, the UE 215 may use IMR m0 for the NCJT hypothesis (e.g., because the interference measurement reflects interference from TRP 205-b and not TRP 205-c). If TRP 205-a is muted during IMR m1, the UE 215 may use IMR m1 for the NCJT hypothesis (e.g., because the interference measurement reflects interference from TRP 205-b and not TRP 205-a). If TRP 205-c is muted during IMR m0 and TRP 205-a is muted during IMR m1, both IMRs may be used for the NCJT hypothesis. Thus, in Case 2, the UE 215 may use IMR m0, IMR m1, or both, for the NCJT hypothesis (depending on which TRPs are muted). For example, the UE 215 may obtain one or more interference measurements using IMR m0, IMR m1, or both, and use the interference measurement(s) to generate CSI for the NCJT hypothesis. Muting a TRP 205 may also be referred to as dynamic point blanking (DPB).

Still referring to Case 2, if the UE 215 uses IMR m0 and IMR m1 for the NCJT hypothesis (and if the UE 215 is capable of simultaneous multi-beam reception), the UE 215 may use two receive beams to perform the interference measurements for each IMR. For example, the UE 215 may use a first receive beam corresponding to TCI state 0 (and therefore corresponding to CMR0) and a second receive beam corresponding to TCI state 1 (and therefore corresponding to CMR1) to perform interference measurements using IMR m0 and IMR m1. The UE 215 may average the interference measurements to obtain an average interference measurement, which may provide greater accuracy relative to other techniques. If the UE only uses IMR m0 for the NCJT hypothesis, the UE 215 may use the first receive beam and the second receive beam to perform the interference measurement. If the UE only uses IMR m1 for the NCJT hypothesis, the UE 215 may use the first receive beam and the second receive beam to perform the interference measurement.

In a third scenario (Case 3), the UE 215 may not support simultaneous multi-beam reception but certain conditions from Case 1 or Case 2 may allow the UE 215 to re-use IMR both m0 and IMR m1 for the NCJT hypothesis. For example, neither CMR may be used for the sTRP hypotheses or both TRPs may be muted. Thus, in Case 3, the UE 215 may use both IMR m0 and IMR m1 for the NCJT hypothesis. However, because the UE 215 does not support simultaneous multi-beam reception in Case 3, the UE 215 may use a single receive beam for each IMR. For example, the UE 215 may use the first receive beam (corresponding TCI state 0 and CMR0) to perform the interference measurement for IMR m0 and may use the second receive beam (corresponding TCI state 1 and CMR1) to perform the interference measurement for IMR m1.

In a fourth scenario (Case 4), the UE 215 may not support simultaneous multi-beam reception and the conditions from Case 1 or Case 2 not be present, which may prevent the UE 215 from re-using IMR m0 and IMR m1 for the NCJT hypothesis. Thus, in Case 4, the UE 215 may use IMR m2 and IMR m3 for the NCJT hypothesis. IMR m2 and IMR m3 may be different than IMR m0 and IMR m1. Because the UE 215 does not support simultaneous multi-beam reception in Case 4, the UE 215 may use the first receive beam (corresponding TCI state 0 and CMR0) to perform the interference measurement for IMR m2 and may use the second receive beam (corresponding TCI state 1 and CMR1) to perform the interference measurement for IMR m3.

In a fifth scenario (Case 5), the UE 215 may not support simultaneous multi-beam reception and certain conditions from Case 1 or Case 2 may be present that allow the UE 215 to re-use either IMR m0 or IMR m1, but not both, for the NCJT hypothesis. For example, CMR0 may be used for sTRP hypothesis 0 but CMR1 may not be used for sTRP hypothesis 1, in which case the UE 215 may re-use IMR m1 for the NCJT hypothesis. Alternatively, CMR1 may be used for sTRP hypothesis 1 but CMR0 may not be used for sTRP hypothesis 0, in which case the UE 215 may re-use IMR m0 for the NCJT hypothesis. As another example, TRP 205-a may be muted during IMR m1 and TRP 205-b may be active (e.g., transmitting) during IMR m0, in which case the UE 215 may re-use IMR m1 (but not IMR m0) for the NCJT hypothesis. Alternatively, TRP 205-b may be muted during IMR m0 and TRP 205-a may be active (e.g., transmitting) during IMR m1, in which case the UE 215 may re-use IMR m0 (but not IMR m1) for the NCJT hypothesis. Thus, in Case 5, the UE 215 may re-use one IMR (e.g., IMR m0 or IMR m1) and use a new IMR (e.g., IMR m2 or IMR m3) for the NCJT hypothesis.

Still referring to Case 5, if IMR m0 and IMR m3 are used for the NCJT hypothesis, the UE 215 may use the first receive beam (corresponding TCI state 0 and CMR0) to perform the interference measurement for IMR m0 and may use the second receive beam (corresponding TCI state 1 and CMR1) to perform the interference measurement for IMR m3. If IMR m1 and IMR m2 are used for the NCJT hypothesis, the UE 215 may use the first receive beam (corresponding TCI state 0 and CMR0) to perform the interference measurement for IMR m2 and may use the second receive beam (corresponding TCI state 1 and CMR1) to perform the interference measurement for IMR m1.

Thus, the UE 215 obtain an interference measurement for an NCJT hypothesis by using one or more IMRs, one or more of which may correspond to a CMR configured for the NCJT hypothesis. Although described separately, aspects of one or more cases may be combined.

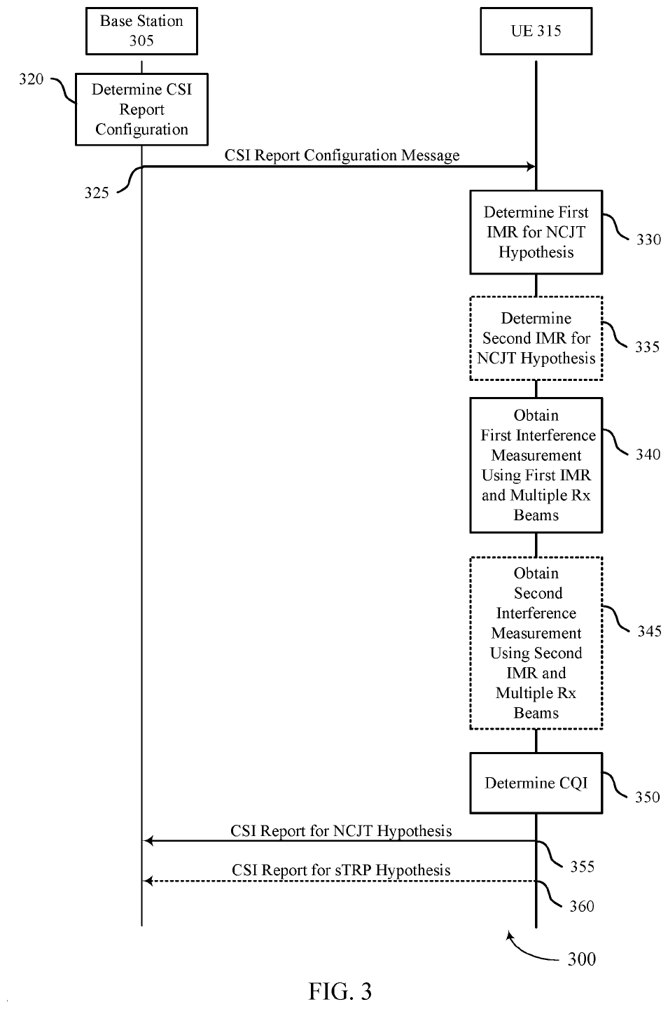

FIG. 3 illustrates an example of a process flow 300 that supports interference measurement resources for channel state information in accordance with aspects of the present disclosure. In some examples, the process flow 300 may be related to aspects of the wireless communications system 100 or the wireless communications system 200. For example, the process flow 300 may be implemented by a base station 305 and a UE 315, which may be examples of a base station or a UE as described herein. The process flow 300 may allow the UE 315 to obtain an interference measurement for an NCJT hypothesis by using one or more IMRs. Process flow 300 may be an example of a process flow in which the UE 315 supports simultaneous multi-beam reception (e.g., a technique in which the UE 315 simultaneously uses multiple receive beams to receive a single transmission). So, aspects of the process flow 300 may correspond to Case 1 and/or Case 2, among other cases.

At 320, the base station 305 may determine a CSI report configuration for the UE 315. At 325, the base station 305 may transmit a CSI report configuration message to the UE 315. The CSI report configuration message may indicate the CSI report configuration and thus may indicate one or more resources for one or more CSI reports. In some examples, the CSI report configuration message may indicate a pair of CMRs that includes a first CMR (e.g., CMR0) and a second CMR (e.g., CMR1). The first CMR may be associated with a first TCI state and a first IMR (e.g., IMR m0) and may (if X is not equal to zero for Option 1) correspond to (e.g., be configured for) a first sTRP hypothesis. The second CMR may be associated with a second TCI state and a second IMR (e.g., IMR m1) and may (if X is not equal to zero for Option 1) correspond to (e.g., be configured for) a second sTRP hypothesis. The first CMR and the second CMR may correspond to (e.g., be configured for) an NCJT hypothesis.

At 330, the UE 315 may determine a first IMR for the NCJT hypothesis. The first IMR may be the IMR associated with the first CMR (e.g., IMR m0) or the IMR associated with the second CMR (e.g., IMR m1). The UE 315 may determine the first IMR based on an explicit indication from the base station 305 or based on one or more implicit rules at the UE 315. At 335, the UE 315 may determine a second IMR for the NCJT hypothesis as described herein. The UE 315 may determine the second IMR for the NCJT hypothesis based on an explicit indication from the base station 305 or based on one or more implicit rules at the UE 315.

If the UE 315 determines the IMR(s) for the NCJT hypothesis based on an explicit indication from the base station 305, the IMR(s) may be configured for the NCJT hypothesis via the CSI report configuration or some other message. In some examples, the IMR(s) indicated by the base station 305 may apply to all the NCJT hypotheses configured in the CSI report configuration. In some examples, the base station 305 may explicitly indicate the IMR(s) for different subsets of the NCJT hypotheses configured in the CSI report configuration. For example, within a CSI report configuration, some NCJT hypotheses may be configured to use the first IMR, some NCJT hypotheses may be configured to use the second IMR, and some NCJT hypotheses may be configured to use both the first IMR and the second IMR. Thus, explicit configuration of IMRs for NCJT hypotheses may be performed on a CSI report configuration basis or on an NCJT hypothesis basis. Put another way, the configuration of IMRs for NCJT hypotheses may be per CSI report configuration or per NCJT hypothesis.

If the UE 315 determines the first IMR based on implicit rules, the UE 315 may use one or more of the following rules, among other rules. According to a first rule (Implicit Rule 1), the UE 315 may determine whether a dedicated IMR (e.g., an IMR unassociated with CMR0 and CMR1, an IMR that is exclusively for the NCJT hypothesis) is configured for the NCJT hypothesis. If a dedicated IMR is configured for the NCJT hypothesis, the UE 315 may select the dedicated IMR as the first IMR for the NCJT hypothesis. If a dedicated IMR is not configured for the NCJT hypothesis, the UE 315 may evaluate a second rule (Implicit Rule 2). According to the second rule, the UE 315 may determine whether the UE 315 is configured with Option 1 for CSI reporting, and if so, whether X is equal to zero. If X is equal to zero, the UE 315 may operate as described with reference to Case 1.

According to a third rule (Implicit Rule 3), the UE 315 may determine whether the UE 315 supports simultaneous multi-beam reception. The UE 315 may determine whether the UE 315 supports simultaneous multi-beam reception in general or in a particular frequency range (e.g., frequency range 2 (FR2), which may cover 24.4 GHz to 52.6 GHz). If the UE 315 does not support simultaneous multi-beam reception, the UE 315 may select the first IMR for the NCJT hypothesis at 330 and may select the second IMR for the NJCT hypothesis at 335. If the UE 315 does support simultaneous multi-beam reception, the UE 315 may select either the first IMR or the second IMR, but not both, for the NCJT hypothesis at 330. In a first alternative (Alternative 1), UE 315 may select the first (and only) IMR to be the IMR that is associated with the first CMR of the CMR pair (which is made up of the first CMR and the second CMR). For example, the UE may select the IMR that is associated with the first-ordered CMR. In a second alternative (Alternative 2), the UE 315 may select the first (and only) IMR to be the IMR that is associated with the CMR (of the CMR pair) that has the lower or higher CSI-RS identifier. Thus, the UE 315 may select an IMR for an NCJT hypothesis based on the relationship between CSI-RS identifiers associated with the CMRs corresponding to the NCJT hypothesis.

According to a fourth rule (Implicit Rule 4), the UE 315 may determine the type of multiplexing used for the hypotheses. If the UE 315 is configured with time division multiplexing (TDM) or frequency division multiplexing (FDM) CSI hypotheses, the UE 315 may select the first IMR for the NCJT hypothesis at 330 and may select the second IMR for the NJCT hypothesis at 335. If the UE 315 is configured with spatial division multiplexing (SDM) or another type of multiplexing different than TDM and FDM, the UE 315 may select either the first IMR or the second IMR, but not both, for the NCJT hypothesis at 330. To decide which IMR to select, the UE may use Alternative 1 or Alternative 2.

At 340, the UE 315 may obtain a first interference measurement using the first IMR (e.g., IMR m0) and using multiple receive beams. For example, the UE 315 may obtain the first interference measurement using a first receive beam that corresponds to the TCI state configured for the first CMR (e.g., CMR0) and a second receive beam that corresponds to the TCI state configured for the second CMR (e.g., CMR1). The interference measured using the first IMR may be referred to as I1 and may reflect interference from TRPs outside the measurement set configured for the UE 315.

At 345, the UE 315 may obtain a second interference measurement using the second IMR (e.g., IMR m1) and using multiple receive beams. For example, the UE 315 may obtain the second interference measurement using the first receive beam that corresponds to the TCI state configured for the first CMR (e.g., CMR0) and the second receive beam that corresponds to the TCI state configured for the second CMR (e.g., CMR1). The interference measured using the second IMR may be referred to as I2 and may reflect interference from TRPs outside the measurement set configured for the UE 315.

At 350, the UE 315 may determine a metric for the NCJT hypothesis. For example, the UE 315 may determine a channel quality indicator (CQI) and/or a signal-to-interference-plus-noise ratio (SINR) for the NCJT hypothesis. In some examples, the CQI may be based on the SINR. If the UE 315 used both IMRs to measure interference for the NCJT hypothesis, the UE 315 may determine the SINR to be (S1+S2)/avg(I1, I2), where S1 is the signal measured using the first CMR (e.g., CMR0), S2 is the signal measured using the second CMR (e.g., CMR1), and avg(I1, I2) is the average of the first and second interference measurements obtained at 340 and 345 using multiple receive (Rx) beams. Thus, the SINR (and therefore the CQI) may be based on the interference measured using the first and second IMRs (e.g., m0, m1). In some examples, the UE 315 may also determine the CQI and/or SINR for one or more of the sTRP hypotheses associated with the pair of CMRs.

At 355, the UE 315 may transmit, and the base station 305 may receive, a CSI report for the NCJT hypothesis (e.g., if the UE 315 is configured with CSI reporting Option 1 or Option 2). The CSI report may include the CQI calculated at 350. At 360, the UE 315 may optionally transmit, and the base station 305 may optionally receive, a CSI report for one of the sTRP hypothesis (e.g., if the UE 315 is configured with CSI reporting Option 1 where X=1 or X=2). The CSI report for the sTRP hypothesis may include CQI calculated for the sTRP hypothesis.

Thus, for an NCJT hypothesis associated with a pair of CMRs, the UE 315 may be configured to use a first IMR associated with the first CMR, a second IMR associated with the second CMR, or both.

Alternative examples of the foregoing may be implemented, where some operations are performed in a different order than described, are performed in parallel, or are not performed at all. In some cases, operations may include additional features not mentioned below, or further operations may be added. Additionally, certain operations may be performed multiple times or certain combinations of operations may repeat or cycle.

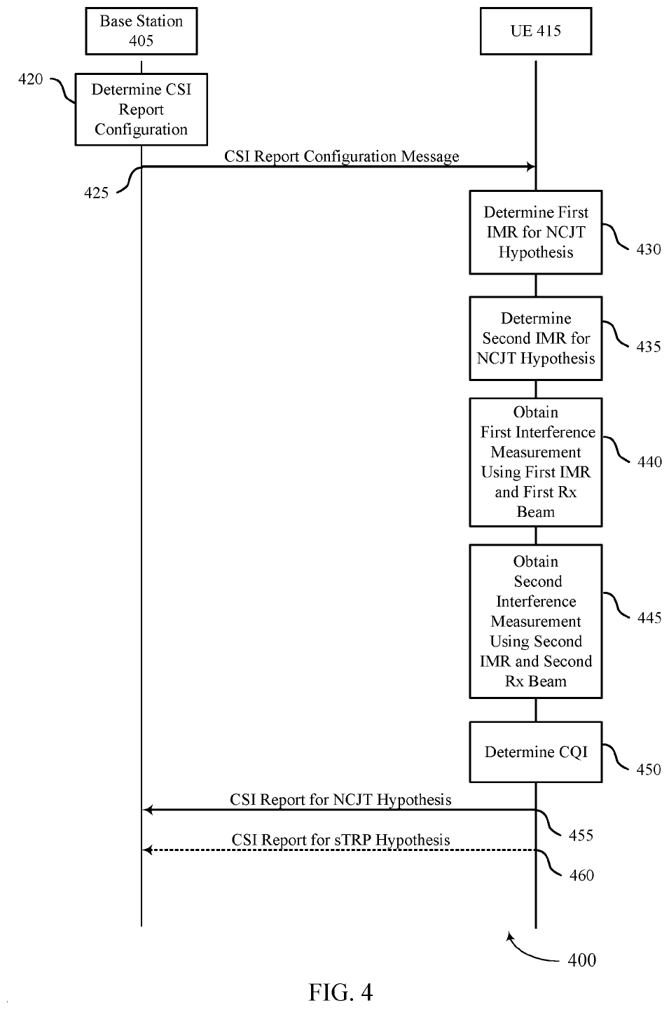

FIG. 4 illustrates an example of a process flow 400 that supports interference measurement resources for channel state information in accordance with aspects of the present disclosure. In some examples, the process flow 400 may be related to aspects of the wireless communications system 100 or the wireless communications system 200. For example, the process flow 400 may be implemented by a base station 405 and a UE 415, which may be examples of a base station or a UE as described herein. The process flow 400 may allow the UE 315 to obtain an interference measurement for an NCJT hypothesis by using multiple IMRs. Process flow 400 may be an example of a process flow in which the UE 315 does not support simultaneous multi-beam reception. So, aspects of the process flow 300 may correspond to Case 3, Case 4, and/or Case 5, among other cases.

At 420, the base station 405 may determine a CSI report configuration for the UE 415. At 425, the base station 405 may transmit a CSI report configuration message to the UE 415. The CSI report configuration message may indicate the CSI report configuration and thus may indicate one or more resources for one or more CSI reports. In some examples, the CSI report configuration message may indicate a pair of CMRs that includes a first CMR (e.g., CMR0) and a second CMR (e.g., CMR1). The first CMR may be associated with a first TCI state and a first IMR (e.g., IMR m0) and may (if X is not equal to zero) correspond to (e.g., be configured for) a first sTRP hypothesis. The second CMR may be associated with a second TCI state and a second IMR (e.g., IMR m1) and may (if X is not equal to zero) correspond to (e.g., be configured for) a second sTRP hypothesis. The first CMR and the second CMR may correspond to (e.g., be configured for) an NCJT hypothesis.

At 430, the UE 415 may determine a first IMR for the NCJT hypothesis. The first IMR may be the IMR that corresponds to the first CMR (e.g., IMR m0) or a different IMR (e.g., IMR 2) that does not correspond to either of the CMRs in the CMR pair. The UE 415 may determine the first IMR based on an explicit indication from the base station 405 or based on one or more implicit rules at the UE 415. At 435, the UE 415 may determine a second IMR for the NCJT hypothesis. The second IMR may be the IMR that corresponds to the first CMR (e.g., IMR m1) or a different IMR (e.g., IMR m3) that does not correspond to either of the CMRs in the CMR pair. The UE 415 may determine the second IMR for the NCJT hypothesis based on an explicit indication from the base station 405 or based on one or more implicit rules at the UE 415. Thus, the UE 415 may determine multiple IMRs for the NCJT hypothesis.

At 440, the UE 415 may obtain a first interference measurement using the first IMR (e.g., IMR m0 or IMR m2) and using a first receive beam that corresponds to the TCI state configured for the first CMR (e.g., CMR0). The interference measured using the first IMR may be referred to as I1 and may reflect interference from TRPs outside the measurement set configured for the UE 415.

At 445, the UE 415 may obtain a second interference measurement using the second IMR (e.g., IMR m1 or IMR m3) and using a second receive beam that corresponds to the TCI state configured for the second CMR (e.g., CMR1). The interference measured using the second IMR may be referred to as I2 and may reflect interference from TRPs outside the measurement set configured for the UE 415.

At 450, the UE 415 may determine a metric for the NCJT hypothesis. For example, the UE 415 may determine a CQI and/or an SINR for the NCJT hypothesis. In some examples, the CQI may be based on the SINR. In one example, the UE 415 may determine the SINR to be (S1+S2)/(I1+I2), where S1 is the signal measured using the first CMR (e.g., CMR0), S2 is the signal measured using the second CMR (e.g., CMR1), and (I1+I2) is the sum of the interference measured using the first and second IMRs. In another example, the UE 415 may determine the SINR to be the average of SINR1 and SINR2, where SINR1=(S1)/(I1) and SINR=(S2)/(I2). Thus, the SINR (and therefore the CQI) may be based on the interference measured using the first and second IMRs. In some examples, the UE 415 may also determine the CQI and/or SINR for one or more of the sTRP hypotheses associated with the pair of CMRs.

At 455, the UE 415 may transmit, and the base station 405 may receive, a CSI report for the NCJT hypothesis (e.g., if the UE 415 is configured with CSI reporting Option 1 or Option 2). The CSI report may include the QCI calculated at 350. At 460, the UE 415 may transmit, and the base station 405 may receive, a CSI report for one of the sTRP hypothesis (e.g., if the UE 415 is configured with CSI reporting Option 1 where X=1 or X=2). The CSI report for the sTRP hypothesis may include CQI calculated for the sTRP hypothesis.

Thus, the UE 315 may be configured to use multiple IMRs for an NCJT hypothesis associated with a pair of CMRs.

Alternative examples of the foregoing may be implemented, where some operations are performed in a different order than described, are performed in parallel, or are not performed at all. In some cases, operations may include additional features not mentioned below, or further operations may be added. Additionally, certain operations may be performed multiple times or certain combinations of operations may repeat or cycle.

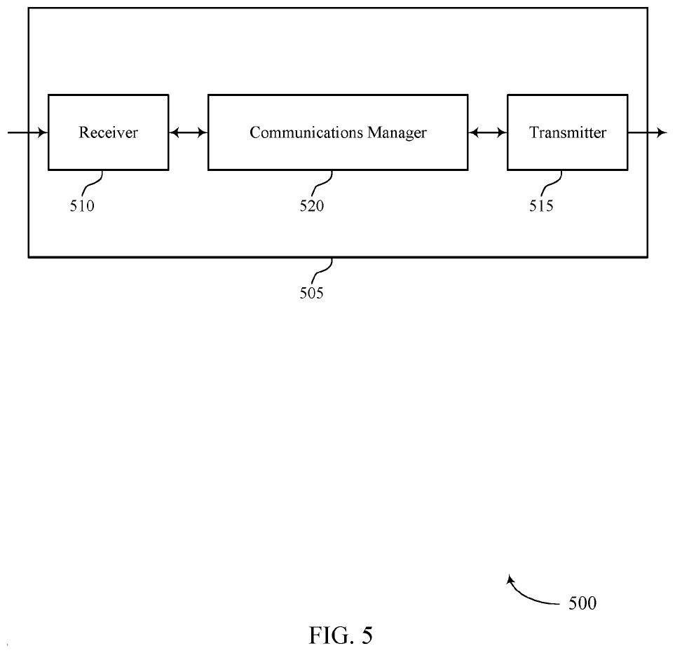

FIG. 5 shows a block diagram 500 of a device 505 that supports interference measurement resources for channel state information in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to interference measurement resources for channel state information). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to interference measurement resources for channel state information). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of interference measurement resources for channel state information as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The communications manager 520 may be configured as or otherwise support a means for receiving an indication of a first interference measurement resource and a second interference measurement resource, the first interference measurement resource associated with the first channel measurement resource and the second interference measurement resource associated with the second channel measurement resource. The communications manager 520 may be configured as or otherwise support a means for obtaining an interference measurement using the first interference measurement resource, the second interference measurement resource, or both, for a channel state information report for a joint transmission hypothesis associated with the first channel measurement resource and the second channel measurement resource. The communications manager 520 may be configured as or otherwise support a means for transmitting the channel state information report based on the interference measurement.

Additionally or alternatively, the communications manager 520 may support wireless communication at a UE in accordance with examples as disclosed herein. For example, the communications manager 520 may be configured as or otherwise support a means for receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state. The communications manager 520 may be configured as or otherwise support a means for receiving an indication of a first interference measurement resource and a second interference measurement resource configured for measuring interference for a joint transmission hypothesis associated with the first channel measurement resource and the second channel measurement resource. The communications manager 520 may be configured as or otherwise support a means for obtaining, for the joint transmission hypothesis, a first interference measurement using the first interference measurement resource and a second interference measurement using the second interference measurement resource. The communications manager 520 may be configured as or otherwise support a means for transmitting a channel state information report based on the first and second interference measurements.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for more efficient utilization of communication resources.

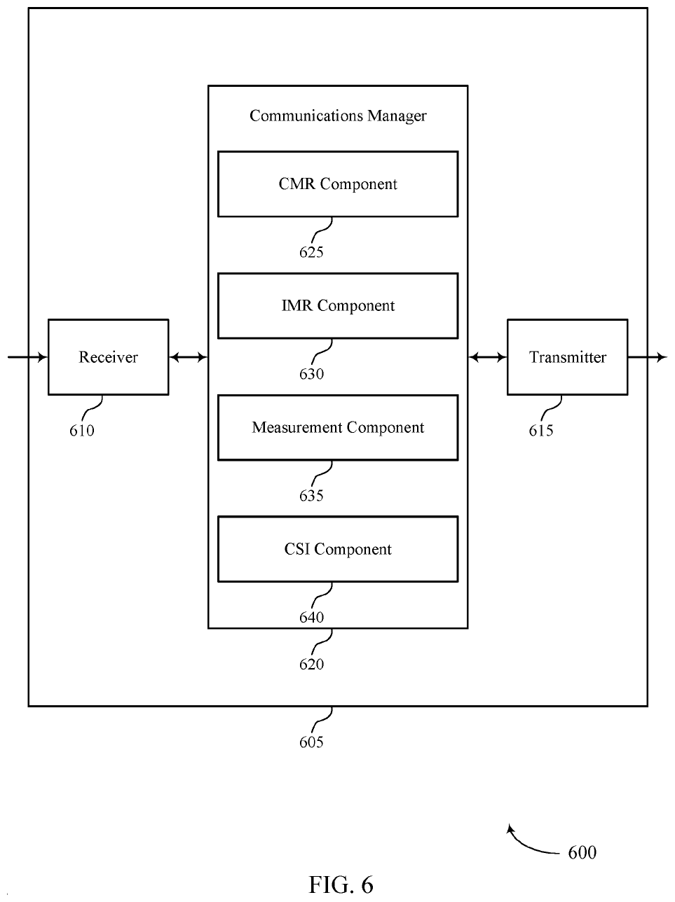

FIG. 6 shows a block diagram 600 of a device 605 that supports interference measurement resources for channel state information in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to interference measurement resources for channel state information). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to interference measurement resources for channel state information). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of interference measurement resources for channel state information as described herein. For example, the communications manager 620 may include an CMR component 625, an IMR component 630, a measurement component 635, a CSI component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The CMR component 625 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The IMR component 630 may be configured as or otherwise support a means for receiving an indication of a first interference measurement resource and a second interference measurement resource, the first interference measurement resource associated with the first channel measurement resource and the second interference measurement resource associated with the second channel measurement resource. The measurement component 635 may be configured as or otherwise support a means for obtaining an interference measurement using the first interference measurement resource, the second interference measurement resource, or both, for a channel state information report for a joint transmission hypothesis associated with the first channel measurement resource and the second channel measurement resource. The CSI component 640 may be configured as or otherwise support a means for transmitting the channel state information report based on the interference measurement.

Additionally or alternatively, the communications manager 620 may support wireless communication at a UE in accordance with examples as disclosed herein. The CMR component 625 may be configured as or otherwise support a means for receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state. The IMR component 630 may be configured as or otherwise support a means for receiving an indication of a first interference measurement resource and a second interference measurement resource configured for measuring interference for a joint transmission hypothesis associated with the first channel measurement resource and the second channel measurement resource. The measurement component 635 may be configured as or otherwise support a means for obtaining, for the joint transmission hypothesis, a first interference measurement using the first interference measurement resource and a second interference measurement using the second interference measurement resource. The CSI component 640 may be configured as or otherwise support a means for transmitting a channel state information report based on the first and second interference measurements.

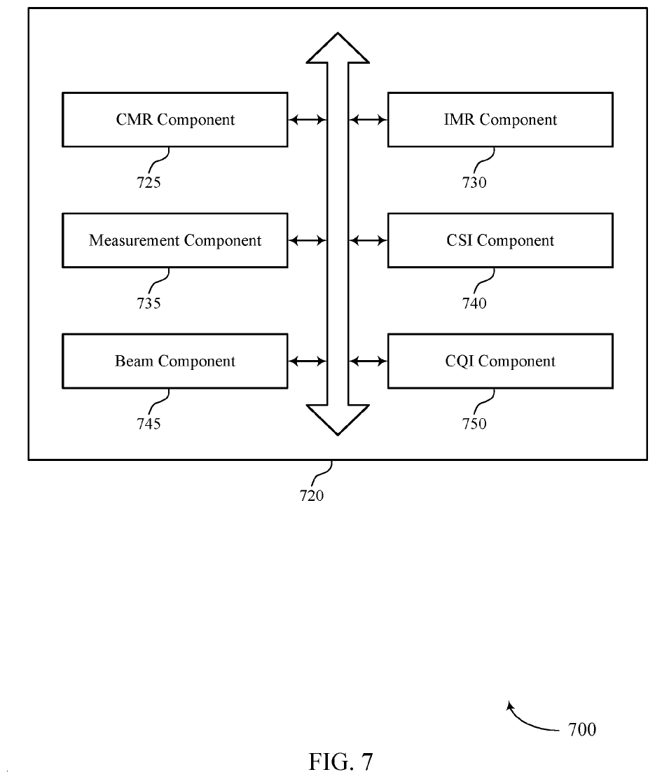

FIG. 7 shows a block diagram 700 of a communications manager 720 that supports interference measurement resources for channel state information in accordance with aspects of the present disclosure. The communications manager 720 may be an example of aspects of a communications manager 520, a communications manager 620, or both, as described herein. The communications manager 720, or various components thereof, may be an example of means for performing various aspects of interference measurement resources for channel state information as described herein. For example, the communications manager 720 may include an CMR component 725, an IMR component 730, a measurement component 735, a CSI component 740, a beam component 745, a CQI component 750, or any combination thereof. Each of these components may communicate, directly or indirectly, with one another (e.g., via one or more buses).

The communications manager 720 may support wireless communication at a UE in accordance with examples as disclosed herein. The CMR component 725 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The IMR component 730 may be configured as or otherwise support a means for receiving an indication of a first interference measurement resource and a second interference measurement resource, the first interference measurement resource associated with the first channel measurement resource and the second interference measurement resource associated with the second channel measurement resource. The measurement component 735 may be configured as or otherwise support a means for obtaining an interference measurement using the first interference measurement resource, the second interference measurement resource, or both, for a channel state information report for a joint transmission hypothesis associated with the first channel measurement resource and the second channel measurement resource. The CSI component 740 may be configured as or otherwise support a means for transmitting the channel state information report based on the interference measurement.

In some examples, the CSI component 740 may be configured as or otherwise support a means for receiving an indication to use the first interference measurement resource, the second interference measurement resource, or both, for the channel state information report for the joint transmission hypothesis.

In some examples, the IMR component 730 may be configured as or otherwise support a means for determining that no interference measurement resource is configured for the joint transmission hypothesis, where the interference measurement is obtained using the first interference measurement resource, the second interference measurement resource, or both, based on the determination.

In some examples, the CSI component 740 may be configured as or otherwise support a means for determining that the UE is to provide zero channel state information reports for single transmission hypotheses, where the interference measurement is obtained using the first interference measurement resource, the second interference measurement resource, or both, based on the determination.

In some examples, the first TCI state corresponds to a first receive beam and the second TCI state corresponds to a second receive beam, and the beam component 745 may be configured as or otherwise support a means for determining that the UE does not support simultaneous multi-beam reception. In some examples, the first TCI state corresponds to a first receive beam and the second TCI state corresponds to a second receive beam, and the beam component 745 may be configured as or otherwise support a means for using the first receive beam for the first interference measurement resource based on the determination. In some examples, the first TCI state corresponds to a first receive beam and the second TCI state corresponds to a second receive beam, and the beam component 745 may be configured as or otherwise support a means for using the second receive beam for the second interference measurement resource based on the determination.

In some examples, the channel state information report includes a CQI, and the CQI component 750 may be configured as or otherwise support a means for determining the CQI based on a sum of interference measured using the first interference measurement resource and interference measured using the second interference measurement resource.

In some examples, the CQI component 750 may be configured as or otherwise support a means for determining a first metric based on interference measured using the first interference measurement resource and signal measured using the first channel measurement resource. In some examples, the CQI component 750 may be configured as or otherwise support a means for determining a second metric based on interference measured using the second interference measurement resource and signal measured using the second channel measurement resource. In some examples, the CQI component 750 may be configured as or otherwise support a means for including, in the channel state information report, a CQI that is based on the first metric and the second metric.

In some examples, the first TCI state corresponds to a first receive beam and the second TCI state corresponds to a second receive beam, and the beam component 745 may be configured as or otherwise support a means for determining that the UE supports simultaneous multi-beam reception. In some examples, the first TCI state corresponds to a first receive beam and the second TCI state corresponds to a second receive beam, and the beam component 745 may be configured as or otherwise support a means for using the first and the second receive beams for the first interference measurement resource or the second interference measurement resource.

In some examples, the channel state information report includes a CQI, and the CQI component 750 may be configured as or otherwise support a means for determining the CQI based on interference measured using the first interference measurement resource and interference measured using the second interference measurement resource.

In some examples, the IMR component 730 may be configured as or otherwise support a means for determining an order for the first channel measurement resource and the second channel measurement resource, where the first and the second receive beams are used for the first interference measurement resource or the second interference measurement resource based on the order.

In some examples, the IMR component 730 may be configured as or otherwise support a means for determining a relationship between an identifier of a CSI-RS for the first channel measurement resource and an identifier of a CSI-RS for the second channel measurement resource, where the first and the second receive beams are used for the first interference measurement resource or the second interference measurement resource based on the relationship.

In some examples, the measurement component 735 may be configured as or otherwise support a means for determining that a TRP associated with the second channel measurement resource is to refrain from transmitting during the first interference measurement resource, where the interference measurement is obtained using the first interference measurement resource based on the determination.

In some examples, the first TCI state corresponds to a first receive beam and the second TCI state corresponds to a second receive beam, and the beam component 745 may be configured as or otherwise support a means for using the first and the second receive beams for the first interference measurement resource. In some examples, the first TCI state corresponds to a first receive beam and the second TCI state corresponds to a second receive beam, and the beam component 745 may be configured as or otherwise support a means for using the first and the second receive beams for the second interference measurement resource.

In some examples, the interference measurement is obtained using the first interference measurement resource or the second interference measurement resource, and the IMR component 730 may be configured as or otherwise support a means for receiving an indication of a third interference measurement resource configured for the joint transmission hypothesis. In some examples, the interference measurement is obtained using the first interference measurement resource or the second interference measurement resource, and the IMR component 730 may be configured as or otherwise support a means for obtaining an interference measurement using the third interference measurement resource for the channel state information report for the joint transmission hypothesis.

Additionally or alternatively, the communications manager 720 may support wireless communication at a UE in accordance with examples as disclosed herein. In some examples, the CMR component 725 may be configured as or otherwise support a means for receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state. In some examples, the IMR component 730 may be configured as or otherwise support a means for receiving an indication of a first interference measurement resource and a second interference measurement resource configured for measuring interference for a joint transmission hypothesis associated with the first channel measurement resource and the second channel measurement resource. In some examples, the measurement component 735 may be configured as or otherwise support a means for obtaining, for the joint transmission hypothesis, a first interference measurement using the first interference measurement resource and a second interference measurement using the second interference measurement resource. In some examples, the CSI component 740 may be configured as or otherwise support a means for transmitting a channel state information report based on the first and second interference measurements.

In some examples, the first transmission configuration indicator (TCI) state corresponds to a first receive beam and the second TCI state corresponds to a second receive beam, and the beam component 745 may be configured as or otherwise support a means for using the first receive beam for the first interference measurement resource. In some examples, the first transmission configuration indicator (TCI) state corresponds to a first receive beam and the second TCI state corresponds to a second receive beam, and the beam component 745 may be configured as or otherwise support a means for using the second receive beam for measuring during the second interference measurement resource.

In some examples, the IMR component 730 may be configured as or otherwise support a means for receiving an indication of a third interference measurement resource and a fourth interference measurement resource each configured for measuring interference for a respective single transmission hypothesis, where the third interference measurement resource and the fourth interference measurement resource are different than the first interference measurement resource and the second interference measurement resource.

In some examples, the channel state information report includes a CQI, and the CQI component 750 may be configured as or otherwise support a means for determining the CQI based on a sum of the first interference measurement and the second interference measurement.

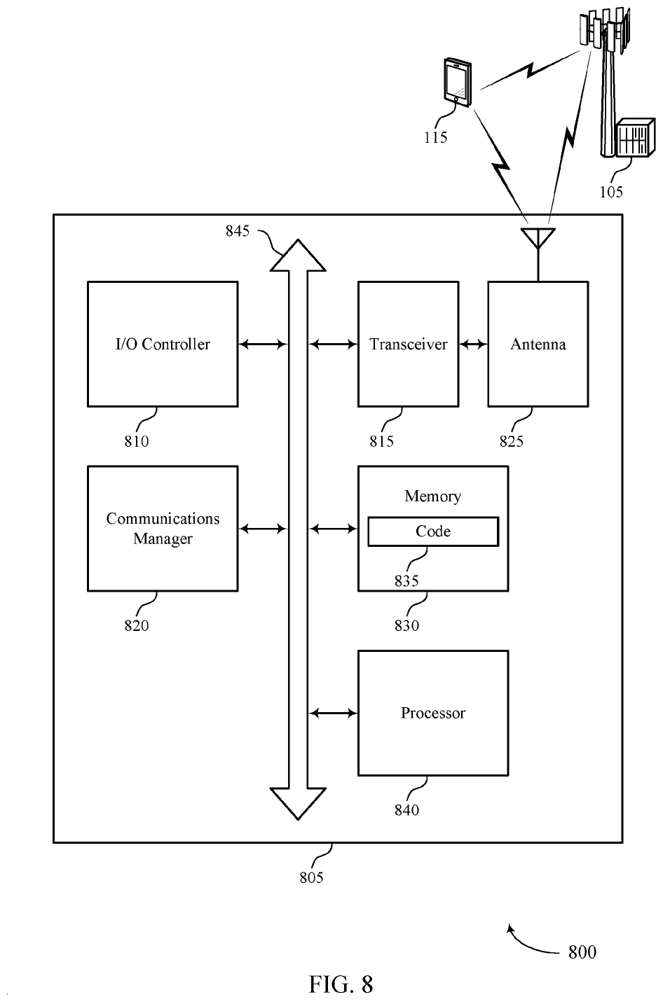

FIG. 8 shows a diagram of a system 800 including a device 805 that supports interference measurement resources for channel state information in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting interference measurement resources for channel state information). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state. The communications manager 820 may be configured as or otherwise support a means for receiving an indication of a first interference measurement resource and a second interference measurement resource, the first interference measurement resource associated with the first channel measurement resource and the second interference measurement resource associated with the second channel measurement resource. The communications manager 820 may be configured as or otherwise support a means for obtaining an interference measurement using the first interference measurement resource, the second interference measurement resource, or both, for a channel state information report for a joint transmission hypothesis associated with the first channel measurement resource and the second channel measurement resource. The communications manager 820 may be configured as or otherwise support a means for transmitting the channel state information report based on the interference measurement.

Additionally or alternatively, the communications manager 820 may support wireless communication at a UE in accordance with examples as disclosed herein. For example, the communications manager 820 may be configured as or otherwise support a means for receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state. The communications manager 820 may be configured as or otherwise support a means for receiving an indication of a first interference measurement resource and a second interference measurement resource configured for measuring interference for a joint transmission hypothesis associated with the first channel measurement resource and the second channel measurement resource. The communications manager 820 may be configured as or otherwise support a means for obtaining, for the joint transmission hypothesis, a first interference measurement using the first interference measurement resource and a second interference measurement using the second interference measurement resource. The communications manager 820 may be configured as or otherwise support a means for transmitting a channel state information report based on the first and second interference measurements.

By including or configuring the communications manager 820 in accordance with examples as described herein, the device 805 may support techniques for more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of interference measurement resources for channel state information as described herein, or the processor 840 and the memory 830 may be otherwise configured to perform or support such operations.

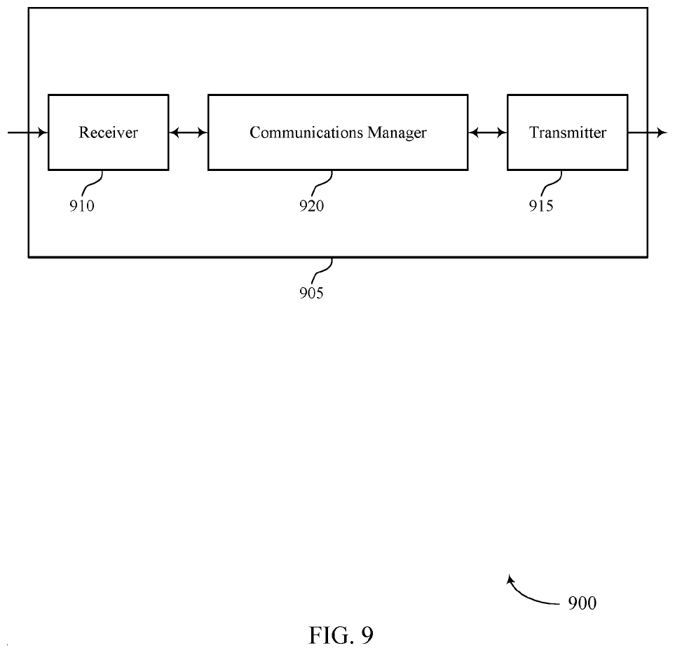

FIG. 9 shows a block diagram 900 of a device 905 that supports interference measurement resources for channel state information in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to interference measurement resources for channel state information). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to interference measurement resources for channel state information). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of interference measurement resources for channel state information as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication in accordance with examples as disclosed herein. For example, the communications manager 920 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The communications manager 920 may be configured as or otherwise support a means for indicating a first interference measurement resource and a second interference measurement resource, the first interference measurement resource associated with the first channel measurement resource and the second interference measurement resource associated with the second channel measurement resource. The communications manager 920 may be configured as or otherwise support a means for receiving a channel state information report for a joint transmission hypothesis associated with the first channel measurement resource and the second channel measurement resource, the channel state information report based on one or more interference measurements obtained using the first interference measurement resource, the second interference measurement resource, or both.

Additionally or alternatively, the communications manager 920 may support wireless communication in accordance with examples as disclosed herein. For example, the communications manager 920 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The communications manager 920 may be configured as or otherwise support a means for indicating a first interference measurement resource and a second interference measurement resource configured for measuring interference for a joint transmission hypothesis associated with the first channel measurement resource and the second channel measurement resource. The communications manager 920 may be configured as or otherwise support a means for receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for more efficient utilization of communication resources.

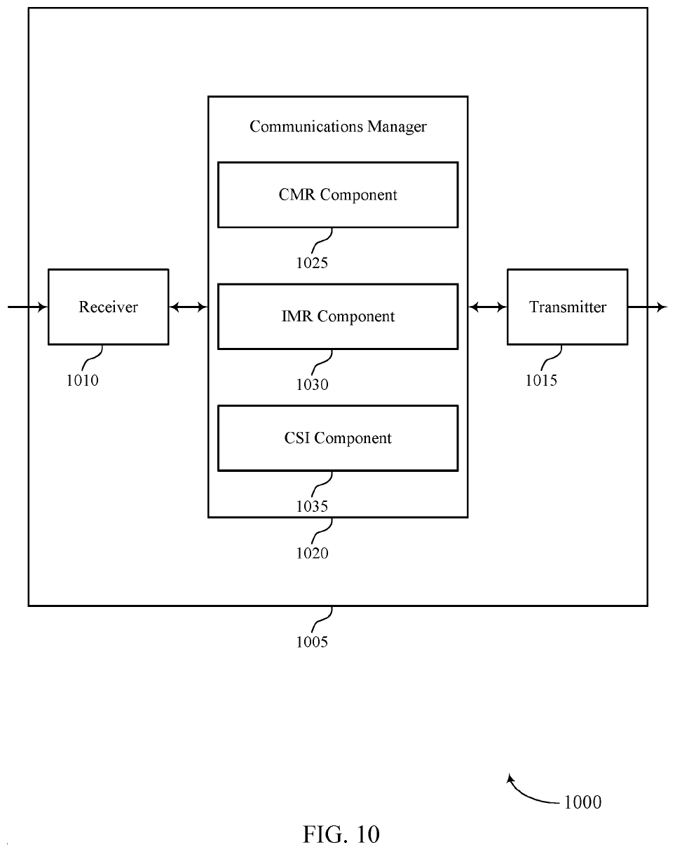

FIG. 10 shows a block diagram 1000 of a device 1005 that supports interference measurement resources for channel state information in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to interference measurement resources for channel state information). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to interference measurement resources for channel state information). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of interference measurement resources for channel state information as described herein. For example, the communications manager 1020 may include an CMR component 1025, an IMR component 1030, a CSI component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication in accordance with examples as disclosed herein. The CMR component 1025 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The IMR component 1030 may be configured as or otherwise support a means for indicating a first interference measurement resource and a second interference measurement resource, the first interference measurement resource associated with the first channel measurement resource and the second interference measurement resource associated with the second channel measurement resource. The CSI component 1035 may be configured as or otherwise support a means for receiving a channel state information report for a joint transmission hypothesis associated with the first channel measurement resource and the second channel measurement resource, the channel state information report based on one or more interference measurements obtained using the first interference measurement resource, the second interference measurement resource, or both.

Additionally or alternatively, the communications manager 1020 may support wireless communication in accordance with examples as disclosed herein. The CMR component 1025 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The IMR component 1030 may be configured as or otherwise support a means for indicating a first interference measurement resource and a second interference measurement resource configured for measuring interference for a joint transmission hypothesis associated with the first channel measurement resource and the second channel measurement resource. The CSI component 1035 may be configured as or otherwise support a means for receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

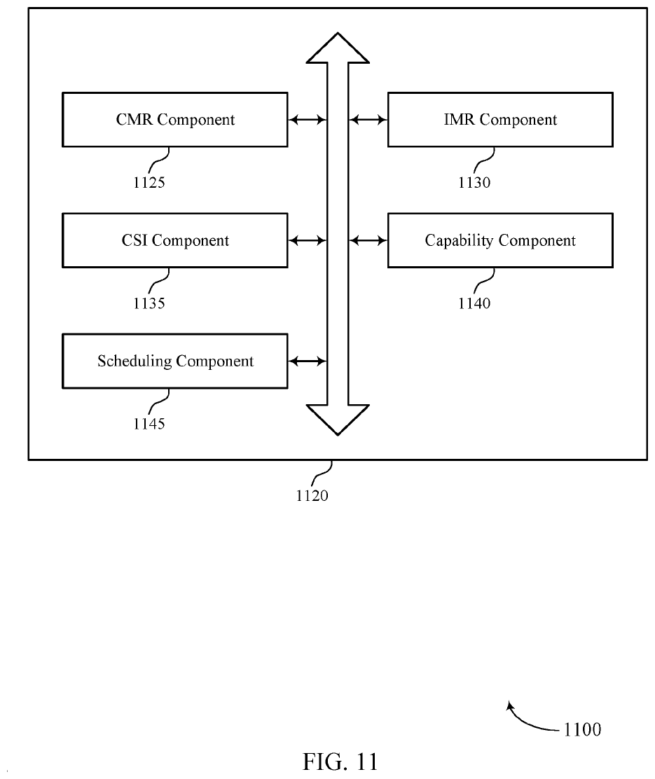

FIG. 11 shows a block diagram 1100 of a communications manager 1120 that supports interference measurement resources for channel state information in accordance with aspects of the present disclosure. The communications manager 1120 may be an example of aspects of a communications manager 920, a communications manager 1020, or both, as described herein. The communications manager 1120, or various components thereof, may be an example of means for performing various aspects of interference measurement resources for channel state information as described herein. For example, the communications manager 1120 may include an CMR component 1125, an IMR component 1130, a CSI component 1135, a capability component 1140, a scheduling component 1145, or any combination thereof. Each of these components may communicate, directly or indirectly, with one another (e.g., via one or more buses).

The communications manager 1120 may support wireless communication in accordance with examples as disclosed herein. The CMR component 1125 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The IMR component 1130 may be configured as or otherwise support a means for indicating a first interference measurement resource and a second interference measurement resource, the first interference measurement resource associated with the first channel measurement resource and the second interference measurement resource associated with the second channel measurement resource. The CSI component 1135 may be configured as or otherwise support a means for receiving a channel state information report for a joint transmission hypothesis associated with the first channel measurement resource and the second channel measurement resource, the channel state information report based on one or more interference measurements obtained using the first interference measurement resource, the second interference measurement resource, or both.

In some examples, the IMR component 1130 may be configured as or otherwise support a means for indicating that a UE is to use the first interference measurement resource, the second interference measurement resource, or both, for the channel state information report for the joint transmission hypothesis.

In some examples, the IMR component 1130 may be configured as or otherwise support a means for determining that no interference measurement resource is configured for the joint transmission hypothesis, where the indication to use the first interference measurement resource, the second interference measurement resource, or both, is transmitted based on the determination.

In some examples, the CSI component 1135 may be configured as or otherwise support a means for configuring a UE to provide zero channel state information reports for single transmission hypotheses, where the indication to use the first interference measurement resource, the second interference measurement resource, or both, is transmitted based on the determination.

In some examples, the scheduling component 1145 may be configured as or otherwise support a means for determining that a TRP associated with the second channel measurement resource is to refrain from transmitting during the first interference measurement resource, where the indication to use the first interference measurement resource, the second interference measurement resource, or both, is transmitted based on the determination.

In some examples, the IMR component 1130 may be configured as or otherwise support a means for determining that a UE does not support simultaneous multi-beam reception. In some examples, the IMR component 1130 may be configured as or otherwise support a means for transmitting an indication of a third interference measurement resource configured for the joint transmission hypothesis based on the determination, where the channel state information report is based on an interference measurement obtained using the third interference measurement resource.

In some examples, the first interference measurement resource and the second interference measurement resource are indicated in a channel state information report configuration message.

Additionally or alternatively, the communications manager 1120 may support wireless communication in accordance with examples as disclosed herein. In some examples, the CMR component 1125 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. In some examples, the IMR component 1130 may be configured as or otherwise support a means for indicating a first interference measurement resource and a second interference measurement resource configured for measuring interference for a joint transmission hypothesis associated with the first channel measurement resource and the second channel measurement resource. In some examples, the CSI component 1135 may be configured as or otherwise support a means for receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

In some examples, the capability component 1140 may be configured as or otherwise support a means for determining that a UE does not support simultaneous multi-beam reception, where the first interference measurement resource and the second interference measurement resource are indicated based on the determination.

In some examples, the CSI component 1135 may be configured as or otherwise support a means for configuring the UE to provide one or more channel state information reports for single transmission hypotheses, where the first interference measurement resource and the second interference measurement resource are indicated based on configuring the UE.

In some examples, the scheduling component 1145 may be configured as or otherwise support a means for determining that a TRP associated with the first channel measurement resource is scheduled to transmit during the second interference measurement resource and that a second TRP associated with the second channel measurement resource is scheduled to transmit during the first interference measurement resource, where the first interference measurement resource and the second interference measurement resource are indicated based on the determination.

In some examples, the IMR component 1130 may be configured as or otherwise support a means for indicating a third interference measurement resource and a fourth interference measurement resource each configured for measuring interference for a respective single transmission hypothesis, where the third interference measurement resource is associated with the first channel measurement resource and the second interference measurement resource is associated with the second channel measurement resource. In some examples, the CSI component 1135 may be configured as or otherwise support a means for receiving a second channel state information report for at least one of the single transmission hypotheses, the second channel state information report including a second interference metric that is based on a third interference measurement obtained using the third interference measurement resource or a fourth interference measurement obtained using the fourth interference measurement resource.

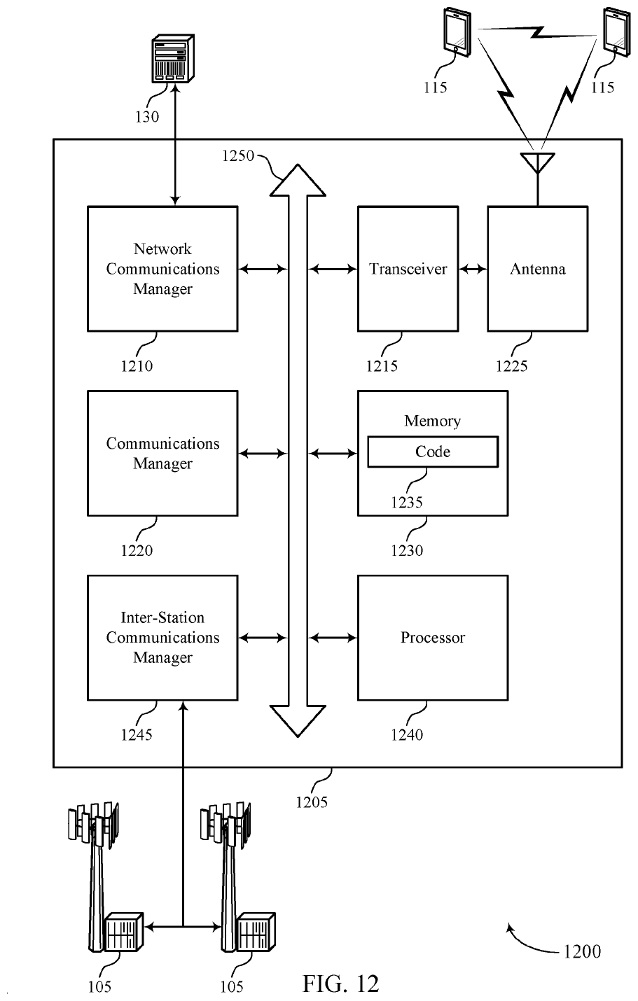

FIG. 12 shows a diagram of a system 1200 including a device 1205 that supports interference measurement resources for channel state information in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting interference measurement resources for channel state information). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105 and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication in accordance with examples as disclosed herein. For example, the communications manager 1220 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The communications manager 1220 may be configured as or otherwise support a means for indicating a first interference measurement resource and a second interference measurement resource, the first interference measurement resource associated with the first channel measurement resource and the second interference measurement resource associated with the second channel measurement resource. The communications manager 1220 may be configured as or otherwise support a means for receiving a channel state information report for a joint transmission hypothesis associated with the first channel measurement resource and the second channel measurement resource, the channel state information report based on one or more interference measurements obtained using the first interference measurement resource, the second interference measurement resource, or both.

Additionally or alternatively, the communications manager 1220 may support wireless communication in accordance with examples as disclosed herein. For example, the communications manager 1220 may be configured as or otherwise support a means for indicating a first channel measurement resource and a second channel measurement resource configured for measuring channel state information reference signals, the first channel measurement resource associated with a first transmission configuration indicator state and the second channel measurement resource associated with a second transmission configuration indicator state. The communications manager 1220 may be configured as or otherwise support a means for indicating a first interference measurement resource and a second interference measurement resource configured for measuring interference for a joint transmission hypothesis associated with the first channel measurement resource and the second channel measurement resource. The communications manager 1220 may be configured as or otherwise support a means for receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource.

By including or configuring the communications manager 1220 in accordance with examples as described herein, the device 1205 may support techniques for more efficient utilization of communication resources.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of interference measurement resources for channel state information as described herein, or the processor 1240 and the memory 1230 may be otherwise configured to perform or support such operations.

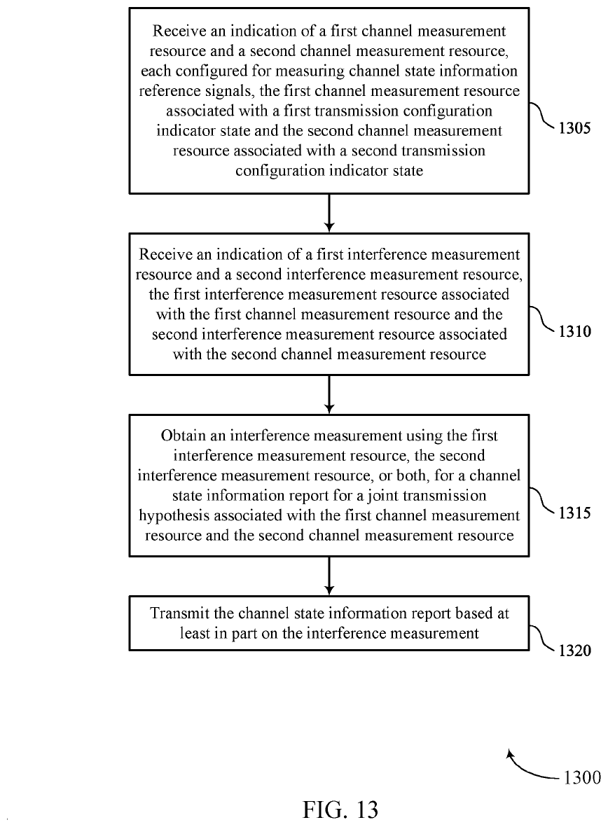

FIG. 13 shows a flowchart illustrating a method 1300 that supports interference measurement resources for channel state information in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving an indication of a first channel measurement resource (e.g., CMR0) and a second channel measurement resource (e.g., CMR1), each configured for measuring channel state information reference signals, the first channel measurement resource associated with a first transmission configuration indicator state (e.g., TCI state 0) and the second channel measurement resource associated with a second transmission configuration indicator state (e.g., TCI state 1). The operations of 1305 may be performed in accordance with examples as disclosed herein. In some examples, aspects of the operations of 1305 may be performed by an CMR component 725 as described with reference to FIG. 7.

At 1310, the method may include receiving an indication of a first interference measurement resource (e.g., IMR m0) and a second interference measurement resource (e.g., IMR m1), the first interference measurement resource associated with the first channel measurement resource (e.g., CMR0) and the second interference measurement resource associated with the second channel measurement resource (e.g., CMR0). The operations of 1310 may be performed in accordance with examples as disclosed herein. In some examples, aspects of the operations of 1310 may be performed by an IMR component 730 as described with reference to FIG. 7.

At 1315, the method may include obtaining an interference measurement using the first interference measurement resource (e.g., IMR m0), the second interference measurement resource (e.g., IMR m1), or both, for a channel state information report for a joint transmission hypothesis associated with the first channel measurement resource (e.g., CMR0) and the second channel measurement resource (e.g., CMR1). The operations of 1315 may be performed in accordance with examples as disclosed herein. In some examples, aspects of the operations of 1315 may be performed by a measurement component 735 as described with reference to FIG. 7.

At 1320, the method may include transmitting the channel state information report based on the interference measurement. The operations of 1320 may be performed in accordance with examples as disclosed herein. In some examples, aspects of the operations of 1320 may be performed by a CSI component 740 as described with reference to FIG. 7.

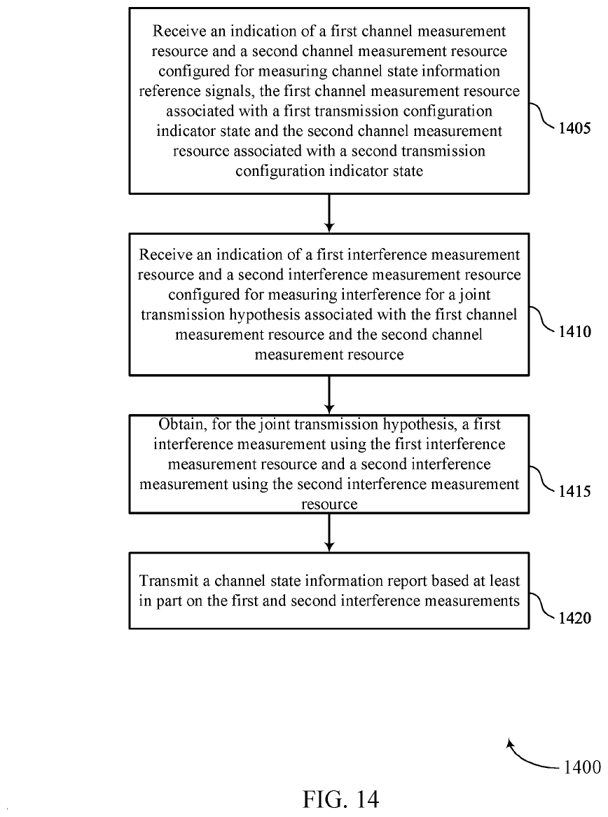

FIG. 14 shows a flowchart illustrating a method 1400 that supports interference measurement resources for channel state information in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving an indication of a first channel measurement resource (e.g., CMR0) and a second channel measurement resource (E.G., cmr1) configured for measuring channel state information reference signals, the first channel measurement resource associated with a first transmission configuration indicator state (e.g., TCI state 0) and the second channel measurement resource associated with a second transmission configuration indicator state (e.g., TCI state 1). The operations of 1405 may be performed in accordance with examples as disclosed herein. In some examples, aspects of the operations of 1405 may be performed by an CMR component 725 as described with reference to FIG. 7.

At 1410, the method may include receiving an indication of a first interference measurement resource (e.g., IMR m2) and a second interference measurement resource (e.g., IMR m3) configured for measuring interference for a joint transmission hypothesis associated with the first channel measurement resource and the second channel measurement resource. The operations of 1410 may be performed in accordance with examples as disclosed herein. In some examples, aspects of the operations of 1410 may be performed by an IMR component 730 as described with reference to FIG. 7.

At 1415, the method may include obtaining, for the joint transmission hypothesis, a first interference measurement using the first interference measurement resource and a second interference measurement using the second interference measurement resource. The operations of 1415 may be performed in accordance with examples as disclosed herein. In some examples, aspects of the operations of 1415 may be performed by a measurement component 735 as described with reference to FIG. 7.

At 1420, the method may include transmitting a channel state information report based on the first and second interference measurements. The operations of 1420 may be performed in accordance with examples as disclosed herein. In some examples, aspects of the operations of 1420 may be performed by a CSI component 740 as described with reference to FIG. 7.

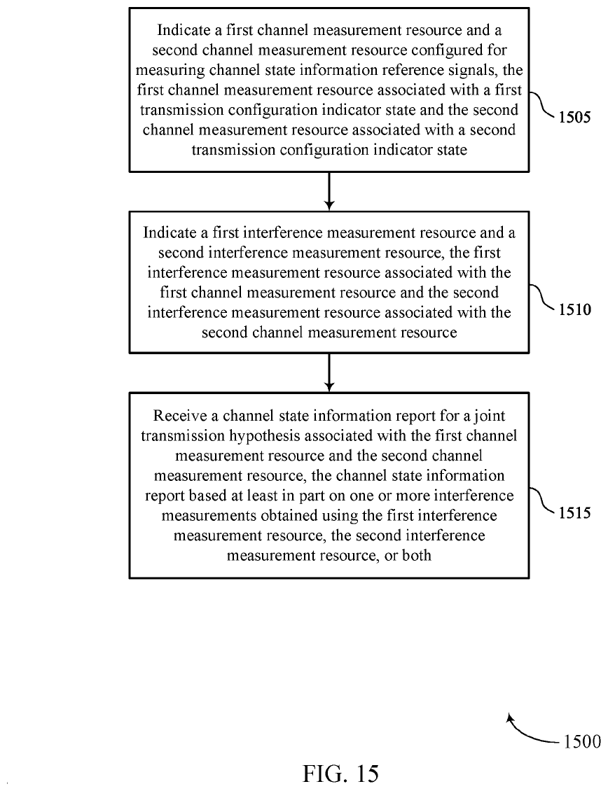

FIG. 15 shows a flowchart illustrating a method 1500 that supports interference measurement resources for channel state information in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include indicating a first channel measurement resource and a second channel measurement resource configured for measuring channel state information reference signals, the first channel measurement resource associated with a first transmission configuration indicator state and the second channel measurement resource associated with a second transmission configuration indicator state. The operations of 1505 may be performed in accordance with examples as disclosed herein. In some examples, aspects of the operations of 1505 may be performed by an CMR component 1125 as described with reference to FIG. 11.

At 1510, the method may include indicating a first interference measurement resource and a second interference measurement resource, the first interference measurement resource associated with the first channel measurement resource and the second interference measurement resource associated with the second channel measurement resource. The operations of 1510 may be performed in accordance with examples as disclosed herein. In some examples, aspects of the operations of 1510 may be performed by an IMR component 1130 as described with reference to FIG. 11.

At 1515, the method may include receiving a channel state information report for a joint transmission hypothesis associated with the first channel measurement resource and the second channel measurement resource, the channel state information report based on one or more interference measurements obtained using the first interference measurement resource, the second interference measurement resource, or both. The operations of 1515 may be performed in accordance with examples as disclosed herein. In some examples, aspects of the operations of 1515 may be performed by a CSI component 1135 as described with reference to FIG. 11.

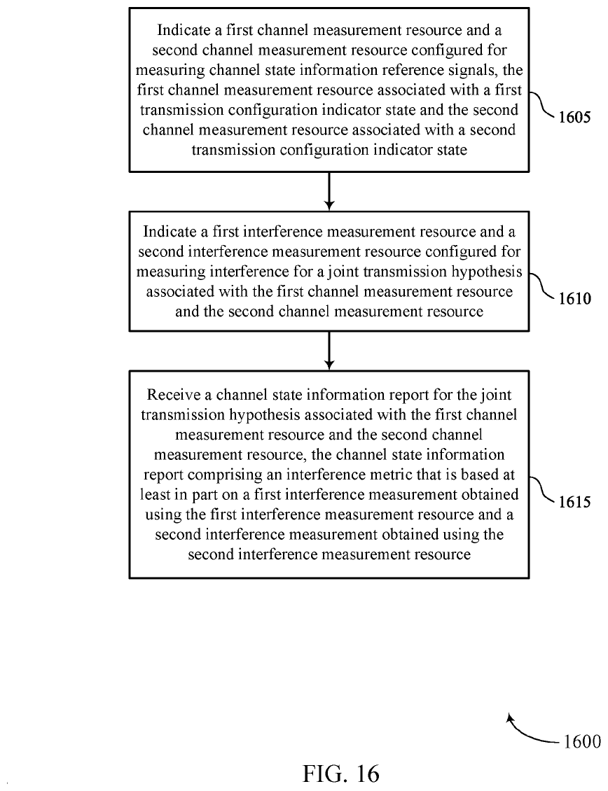

FIG. 16 shows a flowchart illustrating a method 1600 that supports interference measurement resources for channel state information in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include indicating a first channel measurement resource and a second channel measurement resource configured for measuring channel state information reference signals, the first channel measurement resource associated with a first transmission configuration indicator state and the second channel measurement resource associated with a second transmission configuration indicator state. The operations of 1605 may be performed in accordance with examples as disclosed herein. In some examples, aspects of the operations of 1605 may be performed by an CMR component 1125 as described with reference to FIG. 11.

At 1610, the method may include indicating a first interference measurement resource and a second interference measurement resource configured for measuring interference for a joint transmission hypothesis associated with the first channel measurement resource and the second channel measurement resource. The operations of 1610 may be performed in accordance with examples as disclosed herein. In some examples, aspects of the operations of 1610 may be performed by an IMR component 1130 as described with reference to FIG. 11.

At 1615, the method may include receiving a channel state information report for the joint transmission hypothesis associated with the first channel measurement resource and the second channel measurement resource, the channel state information report including an interference metric that is based on a first interference measurement obtained using the first interference measurement resource and a second interference measurement obtained using the second interference measurement resource. The operations of 1615 may be performed in accordance with examples as disclosed herein. In some examples, aspects of the operations of 1615 may be performed by a CSI component 1135 as described with reference to FIG. 11.

The following provides an overview of aspects of the present disclosure:

Aspect 1: A method for wireless communication at a UE, comprising: receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state; receiving an indication of a first interference measurement resource and a second interference measurement resource, the first interference measurement resource associated with the first channel measurement resource and the second interference measurement resource associated with the second channel measurement resource; obtaining an interference measurement using the first interference measurement resource, the second interference measurement resource, or both, for a channel state information report for a joint transmission hypothesis associated with the first channel measurement resource and the second channel measurement resource; and transmitting the channel state information report based at least in part on the interference measurement.

Aspect 2: The method of aspect 1, further comprising: receiving an indication to use the first interference measurement resource, the second interference measurement resource, or both, for the channel state information report for the joint transmission hypothesis.

Aspect 3: The method of any of aspects 1 through 2, further comprising: determining that no interference measurement resource is configured for the joint transmission hypothesis, wherein the interference measurement is obtained using the first interference measurement resource, the second interference measurement resource, or both, based at least in part on the determination.

Aspect 4: The method of any of aspects 1 through 3, further comprising: determining that the UE is to provide zero channel state information reports for single transmission hypotheses, wherein the interference measurement is obtained using the first interference measurement resource, the second interference measurement resource, or both, based at least in part on the determination.

Aspect 5: The method of any of aspects 1 through 4, wherein the first TCJ state corresponds to a first receive beam and the second TCJ state corresponds to a second receive beam, the method further comprising: determining that the UE does not support simultaneous multi-beam reception; using the first receive beam for the first interference measurement resource based at least in part on the determination; and using the second receive beam for the second interference measurement resource based at least in part on the determination.

Aspect 6: The method of aspect 5, wherein the channel state information report comprises a CQI, the method further comprising: determining the CQI based at least in part on a sum of interference measured using the first interference measurement resource and interference measured using the second interference measurement resource.

Aspect 7: The method of aspect 5, further comprising: determining a first metric based at least in part on interference measured using the first interference measurement resource and signal measured using the first channel measurement resource; determining a second metric based at least in part on interference measured using the second interference measurement resource and signal measured using the second channel measurement resource; and including, in the channel state information report, a CQI that is based at least in part on the first metric and the second metric.

Aspect 8: The method of any of aspects 1 through 4, wherein the first TCI state corresponds to a first receive beam and the second TCI state corresponds to a second receive beam, the method further comprising: determining that the UE supports simultaneous multi-beam reception; and using the first and the second receive beams for the first interference measurement resource or the second interference measurement resource.

Aspect 9: The method of aspect 8, wherein the channel state information report comprises a CQI, the method further comprising: determining the CQI based at least in part on interference measured using the first interference measurement resource and interference measured using the second interference measurement resource.

Aspect 10: The method of any of aspects 8 through 9, further comprising: determining an order for the first channel measurement resource and the second channel measurement resource, wherein the first and the second receive beams are used for the first interference measurement resource or the second interference measurement resource based at least in part on the order.

Aspect 11: The method of any of aspects 8 through 9, further comprising: determining a relationship between an identifier of a channel state information reference signal (CSI-RS) for the first channel measurement resource and an identifier of a CSI-RS for the second channel measurement resource, wherein the first and the second receive beams are used for the first interference measurement resource or the second interference measurement resource based at least in part on the relationship.

Aspect 12: The method of any of aspects 1 through 11, further comprising: determining that a TRP associated with the second channel measurement resource is to refrain from transmitting during the first interference measurement resource, wherein the interference measurement is obtained using the first interference measurement resource based at least in part on the determination.

Aspect 13: The method of any of aspects 1 through 4 and 8 through 12, wherein the first TCJ state corresponds to a first receive beam and the second TCJ state corresponds to a second receive beam, the method further comprising: using the first and the second receive beams for the first interference measurement resource; and using the first and the second receive beams for the second interference measurement resource.

Aspect 14: The method of any of aspects 1 through 13, wherein the interference measurement is obtained using the first interference measurement resource or the second interference measurement resource, the method further comprising: receiving an indication of a third interference measurement resource configured for the joint transmission hypothesis; and obtaining an interference measurement using the third interference measurement resource for the channel state information report for the joint transmission hypothesis.

Aspect 15: A method for wireless communication at a UE, comprising: receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state; receiving an indication of a first interference measurement resource and a second interference measurement resource configured for measuring interference for a joint transmission hypothesis associated with the first channel measurement resource and the second channel measurement resource; obtaining, for the joint transmission hypothesis, a first interference measurement using the first interference measurement resource and a second interference measurement using the second interference measurement resource; and transmitting a channel state information report based at least in part on the first and second interference measurements.

Aspect 16: The method of aspect 15, wherein the first TCI state corresponds to a first receive beam and the second TCI state corresponds to a second receive beam, the method further comprising: using the first receive beam for the first interference measurement resource; and using the second receive beam for measuring during the second interference measurement resource.

Aspect 17: The method of aspect 16, further comprising: receiving an indication of a third interference measurement resource and a fourth interference measurement resource each configured for measuring interference for a respective single transmission hypothesis, wherein the third interference measurement resource and the fourth interference measurement resource are different than the first interference measurement resource and the second interference measurement resource.

Aspect 18: The method of any of aspects 16 through 17, wherein the channel state information report comprises a CQI, the method further comprising: determining the CQI based at least in part on a sum of the first interference measurement and the second interference measurement.

Aspect 19: A method for wireless communication, comprising: indicating a first channel measurement resource and a second channel measurement resource configured for measuring channel state information reference signals, the first channel measurement resource associated with a first transmission configuration indicator state and the second channel measurement resource associated with a second transmission configuration indicator state; indicating a first interference measurement resource and a second interference measurement resource, the first interference measurement resource associated with the first channel measurement resource and the second interference measurement resource associated with the second channel measurement resource; and receiving a channel state information report for a joint transmission hypothesis associated with the first channel measurement resource and the second channel measurement resource, the channel state information report based at least in part on one or more interference measurements obtained using the first interference measurement resource, the second interference measurement resource, or both.

Aspect 20: The method of aspect 19, further comprising: indicating that a UE is to use the first interference measurement resource, the second interference measurement resource, or both, for the channel state information report for the joint transmission hypothesis.

Aspect 21: The method of aspect 20, further comprising: determining that no interference measurement resource is configured for the joint transmission hypothesis, wherein the indication to use the first interference measurement resource, the second interference measurement resource, or both, is transmitted based at least in part on the determination.

Aspect 22: The method of any of aspects 20 through 21, further comprising: configuring a UE to provide zero channel state information reports for single transmission hypotheses, wherein the indication to use the first interference measurement resource, the second interference measurement resource, or both, is transmitted based at least in part on the determination.

Aspect 23: The method of any of aspects 20 through 22, further comprising: determining that a TRP associated with the second channel measurement resource is to refrain from transmitting during the first interference measurement resource, wherein the indication to use the first interference measurement resource, the second interference measurement resource, or both, is transmitted based at least in part on the determination.

Aspect 24: The method of any of aspects 19 and 20, further comprising: determining that a UE does not support simultaneous multi-beam reception; and transmitting an indication of a third interference measurement resource configured for the joint transmission hypothesis based at least in part on the determination, wherein the channel state information report is based at least in part on an interference measurement obtained using the third interference measurement resource.

Aspect 25: The method of any of aspects 19 through 24, wherein the first interference measurement resource and the second interference measurement resource are indicated in a channel state information report configuration message.

Aspect 26: A method for wireless communication, comprising: indicating a first channel measurement resource and a second channel measurement resource configured for measuring channel state information reference signals, the first channel measurement resource associated with a first transmission configuration indicator state and the second channel measurement resource associated with a second transmission configuration indicator state; indicating a first interference measurement resource and a second interference measurement resource configured for measuring interference for a joint transmission hypothesis associated with the first channel measurement resource and the second channel measurement resource; and receiving a channel state information report for the joint transmission hypothesis associated with the first channel measurement resource and the second channel measurement resource, the channel state information report comprising an interference metric that is based at least in part on a first interference measurement obtained using the first interference measurement resource and a second interference measurement obtained using the second interference measurement resource.

Aspect 27: The method of aspect 26, further comprising: determining that a UE does not support simultaneous multi-beam reception, wherein the first interference measurement resource and the second interference measurement resource are indicated based at least in part on the determination.

Aspect 28: The method of aspect 27, further comprising: configuring the UE to provide one or more channel state information reports for single transmission hypotheses, wherein the first interference measurement resource and the second interference measurement resource are indicated based at least in part on configuring the UE.

Aspect 29: The method of any of aspects 27 through 28, further comprising: determining that a first TRP associated with the first channel measurement resource is scheduled to transmit during the second interference measurement resource and that a second TRP associated with the second channel measurement resource is scheduled to transmit during the first interference measurement resource, wherein the first interference measurement resource and the second interference measurement resource are indicated based at least in part on the determination.

Aspect 30: The method of any of aspects 26 through 29, further comprising: indicating a third interference measurement resource and a fourth interference measurement resource each configured for measuring interference for a respective single transmission hypothesis, wherein the third interference measurement resource is associated with the first channel measurement resource and the second interference measurement resource is associated with the second channel measurement resource; and receiving a second channel state information report for at least one of the single transmission hypotheses, the second channel state information report comprising a second interference metric that is based at least in part on a third interference measurement obtained using the third interference measurement resource or a fourth interference measurement obtained using the fourth interference measurement resource.

Aspect 31: An apparatus for wireless communication at a UE, comprising a processor; memory coupled with the processor; and instructions stored in the memory and executable by the processor to cause the apparatus to perform a method of any of aspects 1 through 14.

Aspect 32: An apparatus for wireless communication at a UE, comprising at least one means for performing a method of any of aspects 1 through 14.

Aspect 33: A non-transitory computer-readable medium storing code for wireless communication at a UE, the code comprising instructions executable by a processor to perform a method of any of aspects 1 through 14.

Aspect 34: An apparatus for wireless communication at a UE, comprising a processor; memory coupled with the processor; and instructions stored in the memory and executable by the processor to cause the apparatus to perform a method of any of aspects 15 through 18.

Aspect 35: An apparatus for wireless communication at a UE, comprising at least one means for performing a method of any of aspects 15 through 18.

Aspect 36: A non-transitory computer-readable medium storing code for wireless communication at a UE, the code comprising instructions executable by a processor to perform a method of any of aspects 15 through 18.

Aspect 37: An apparatus for wireless communication, comprising a processor; memory coupled with the processor; and instructions stored in the memory and executable by the processor to cause the apparatus to perform a method of any of aspects 19 through 25.

Aspect 38: An apparatus for wireless communication, comprising at least one means for performing a method of any of aspects 19 through 25.

Aspect 39: A non-transitory computer-readable medium storing code for wireless communication, the code comprising instructions executable by a processor to perform a method of any of aspects 19 through 25.

Aspect 40: An apparatus for wireless communication, comprising a processor; memory coupled with the processor; and instructions stored in the memory and executable by the processor to cause the apparatus to perform a method of any of aspects 26 through 30.

Aspect 41: An apparatus for wireless communication, comprising at least one means for performing a method of any of aspects 26 through 30.

Aspect 42: A non-transitory computer-readable medium storing code for wireless communication, the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving an indication of a first channel measurement resource and a second channel measurement resource, each configured for measuring channel state information reference signals, the first channel measurement resource associated with a first transmission configuration indicator state and the second channel measurement resource associated with a second transmission configuration indicator state;
receiving an indication of a first interference measurement resource and a second interference measurement resource, the first interference measurement resource associated with the first channel measurement resource and the second interference measurement resource associated with the second channel measurement resource;
obtaining an interference measurement using the first interference measurement resource, the second interference measurement resource, or both, for a channel state information report for a joint transmission hypothesis associated with the first channel measurement resource and the second channel measurement resource; and
transmitting the channel state information report based at least in part on the interference measurement.

2. The method of claim 1, further comprising:
receiving an indication to use the first interference measurement resource, the second interference measurement resource, or both, for the channel state information report for the joint transmission hypothesis.

3. The method of claim 1, further comprising:
determining that no interference measurement resource is configured for the joint transmission hypothesis, wherein the interference measurement is obtained using the first interference measurement resource, the second interference measurement resource, or both, based at least in part on the determination.

4. The method of claim 1, further comprising:
determining that the UE is to provide zero channel state information reports for single transmission hypotheses, wherein the interference measurement is obtained using the first interference measurement resource, the second interference measurement resource, or both, based at least in part on the determination.

5. The method of claim 1, wherein the first transmission configuration indicator (TCI) state corresponds to a first receive beam and the second TCJ state corresponds to a second receive beam, the method further comprising:
determining that the UE does not support simultaneous multi-beam reception;
using the first receive beam for the first interference measurement resource based at least in part on the determination; and
using the second receive beam for the second interference measurement resource based at least in part on the determination.

6. The method of claim 5, wherein the channel state information report comprises a channel quality indicator (CQI), the method further comprising:
determining the CQI based at least in part on a sum of interference measured using the first interference measurement resource and interference measured using the second interference measurement resource.

7. The method of claim 5, further comprising:
determining a first metric based at least in part on interference measured using the first interference measurement resource and signal measured using the first channel measurement resource;
determining a second metric based at least in part on interference measured using the second interference measurement resource and signal measured using the second channel measurement resource; and
including, in the channel state information report, a channel quality indicator (CQI) that is based at least in part on the first metric and the second metric.

8. The method of claim 1, wherein the first transmission configuration indicator (TCI) state corresponds to a first receive beam and the second TCJ state corresponds to a second receive beam, the method further comprising:
determining that the UE supports simultaneous multi-beam reception; and
using the first and the second receive beams for the first interference measurement resource or the second interference measurement resource.

9. The method of claim 8, wherein the channel state information report comprises a channel quality indicator (CQI), the method further comprising:
determining the CQI based at least in part on interference measured using the first interference measurement resource and interference measured using the second interference measurement resource.

10. The method of claim 8, further comprising:
determining an order for the first channel measurement resource and the second channel measurement resource, wherein the first and the second receive beams are used for the first interference measurement resource or the second interference measurement resource based at least in part on the order.

11. The method of claim 8, further comprising:
determining a relationship between an identifier of a channel state information reference signal (CSI-RS) for the first channel measurement resource and an identifier of a CSI-RS for the second channel measurement resource, wherein the first and the second receive beams are used for the first interference measurement resource or the second interference measurement resource based at least in part on the relationship.

12. The method of claim 1, further comprising:
determining that a transmission reception point (TRP) associated with the second channel measurement resource is to refrain from transmitting during the first interference measurement resource, wherein the interference measurement is obtained using the first interference measurement resource based at least in part on the determination.

13. The method of claim 1, wherein the first transmission configuration indicator (TCI) state corresponds to a first receive beam and the second TCJ state corresponds to a second receive beam, the method further comprising:
using the first and the second receive beams for the first interference measurement resource; and
using the first and the second receive beams for the second interference measurement resource.

14. The method of claim 1, wherein the interference measurement is obtained using the first interference measurement resource or the second interference measurement resource, the method further comprising:
receiving an indication of a third interference measurement resource configured for the joint transmission hypothesis; and
obtaining an interference measurement using the third interference measurement resource for the channel state information report for the joint transmission hypothesis.

15. A method for wireless communication at a user equipment (UE), comprising:
receiving an indication of a first channel measurement resource and a second channel measurement resource configured for measuring channel state information reference signals, the first channel measurement resource associated with a first transmission configuration indicator state and the second channel measurement resource associated with a second transmission configuration indicator state;
receiving an indication of a first interference measurement resource and a second interference measurement resource configured for measuring interference for a joint transmission hypothesis associated with the first channel measurement resource and the second channel measurement resource;
obtaining, for the joint transmission hypothesis, a first interference measurement using the first interference measurement resource and a second interference measurement using the second interference measurement resource; and
transmitting a channel state information report based at least in part on the first and second interference measurements.

16. The method of claim 15, wherein the first transmission configuration indicator (TCI) state corresponds to a first receive beam and the second TCJ state corresponds to a second receive beam, the method further comprising:
using the first receive beam for the first interference measurement resource; and
using the second receive beam for measuring during the second interference measurement resource.

17. The method of claim 16, further comprising:
receiving an indication of a third interference measurement resource and a fourth interference measurement resource each configured for measuring interference for a respective single transmission hypothesis, wherein the third interference measurement resource and the fourth interference measurement resource are different than the first interference measurement resource and the second interference measurement resource.

18. The method of claim 16, wherein the channel state information report comprises a channel quality indicator (CQI), the method further comprising:
determining the CQI based at least in part on a sum of the first interference measurement and the second interference measurement.

19. A method for wireless communication, comprising:
indicating a first channel measurement resource and a second channel measurement resource configured for measuring channel state information reference signals, the first channel measurement resource associated with a first transmission configuration indicator state and the second channel measurement resource associated with a second transmission configuration indicator state;
indicating a first interference measurement resource and a second interference measurement resource, the first interference measurement resource associated with the first channel measurement resource and the second interference measurement resource associated with the second channel measurement resource; and
receiving a channel state information report for a joint transmission hypothesis associated with the first channel measurement resource and the second channel measurement resource, the channel state information report based at least in part on one or more interference measurements obtained using the first interference measurement resource, the second interference measurement resource, or both.

20. The method of claim 19, further comprising:
indicating that a user equipment (UE) is to use the first interference measurement resource, the second interference measurement resource, or both, for the channel state information report for the joint transmission hypothesis.

21. The method of claim 20, further comprising:
determining that no interference measurement resource is configured for the joint transmission hypothesis, wherein the indication to use the first interference measurement resource, the second interference measurement resource, or both, is transmitted based at least in part on the determination.

22. The method of claim 20, further comprising:
configuring the UE to provide zero channel state information reports for single transmission hypotheses, wherein the indication to use the first interference measurement resource, the second interference measurement resource, or both, is transmitted based at least in part on the determination.

23. The method of claim 20, further comprising:
determining that a transmission reception point (TRP) associated with the second channel measurement resource is to refrain from transmitting during the first interference measurement resource, wherein the indication to use the first interference measurement resource, the second interference measurement resource, or both, is transmitted based at least in part on the determination.

24. The method of claim 19, further comprising:
determining that a user equipment (UE) does not support simultaneous multi-beam reception; and
transmitting an indication of a third interference measurement resource configured for the joint transmission hypothesis based at least in part on the determination, wherein the channel state information report is based at least in part on an interference measurement obtained using the third interference measurement resource.

25. The method of claim 19, wherein the first interference measurement resource and the second interference measurement resource are indicated in a channel state information report configuration message.

26. A method for wireless communication, comprising:
indicating a first channel measurement resource and a second channel measurement resource configured for measuring channel state information reference signals, the first channel measurement resource associated with a first transmission configuration indicator state and the second channel measurement resource associated with a second transmission configuration indicator state;
indicating a first interference measurement resource and a second interference measurement resource configured for measuring interference for a joint transmission hypothesis associated with the first channel measurement resource and the second channel measurement resource; and
receiving a channel state information report for the joint transmission hypothesis associated with the first channel measurement resource and the second channel measurement resource, the channel state information report comprising an interference metric that is based at least in part on a first interference measurement obtained using the first interference measurement resource and a second interference measurement obtained using the second interference measurement resource.

27. The method of claim 26, further comprising:
determining that a user equipment (UE) does not support simultaneous multi-beam reception, wherein the first interference measurement resource and the second interference measurement resource are indicated based at least in part on the determination.

28. The method of claim 27, further comprising:
configuring the UE to provide one or more channel state information reports for single transmission hypotheses, wherein the first interference measurement resource and the second interference measurement resource are indicated based at least in part on configuring the UE.

29. The method of claim 27, further comprising:
determining that a first transmission reception point (TRP) associated with the first channel measurement resource is scheduled to transmit during the second interference measurement resource and that a second TRP associated with the second channel measurement resource is scheduled to transmit during the first interference measurement resource, wherein the first interference measurement resource and the second interference measurement resource are indicated based at least in part on the determination.

30. The method of claim 26, further comprising:
indicating a third interference measurement resource and a fourth interference measurement resource each configured for measuring interference for a respective single transmission hypothesis, wherein the third interference measurement resource is associated with the first channel measurement resource and the second interference measurement resource is associated with the second channel measurement resource; and
receiving a second channel state information report for at least one of the single transmission hypotheses, the second channel state information report comprising a second interference metric that is based at least in part on a third interference measurement obtained using the third interference measurement resource or a fourth interference measurement obtained using the fourth interference measurement resource.
